(19) United States
(12) Patent Application Publication
(10) Pub. No.: US 2025/0317594 A1
(43) Pub. Date: Oct. 9, 2025

(54) CODING AND DECODING OF VIDEO CODING MODES

(71) Applicants: Beijing Bytedance Network Technology Co., Ltd., Beijing (CN); Bytedance Inc., Los Angeles, CA (US)

(72) Inventors: Hongbin Liu, Beijing (CN); Li Zhang, San Diego, CA (US); Kai Zhang, San Diego, CA (US); Jizheng Xu, San Diego, CA (US); Yue Wang, Beijing (CN)

(21) Appl. No.: 19/242,345

(22) Filed: Jun. 18, 2025

Related U.S. Application Data
(63) Continuation of application No. 17/317,522, filed on May 11, 2021, now Pat. No. 12,348,760.
Application No. 17/317,522 is a continuation of application No. PCT/CN2019/119763, filed on Nov. 20, 2019.

(30) Foreign Application Priority Data
Nov. 20, 2018 (WO) PCT/CN2018/116371
Apr. 2, 2019 (WO) PCT/CN2019/081155
May 7, 2019 (WO) PCT/CN2019/085796

(51) Int. Cl. H04N 19/517; H04N 19/105; H04N 19/132; H04N 19/137; H04N 19/139; H04N 19/159; H04N 19/176; H04N 19/196; H04N 19/513; H04N 19/573; H04N 19/577

(52) U.S. Cl. CPC H04N 19/517; H04N 19/105; H04N 19/132; H04N 19/137; H04N 19/139; H04N 19/159; H04N 19/176; H04N 19/196; H04N 19/521; H04N 19/573; H04N 19/577

(57) ABSTRACT

A method for processing a video includes performing a conversion between a current block of visual media data and a corresponding coded representation of the visual media data. The conversion of the current block includes determining whether a use of one or both of a bi-directional optical flow (BIO) technique or a decoder-side motion vector refinement (DMVR) technique to the current block is enabled or disabled. The use of the BIO technique or the DMVR technique is based on a cost criterion associated with the current block.

### CROSS REFERENCE TO RELATED APPLICATIONS

This is a continuation of U.S. application Ser. No. 17/317,522, filed on May 11, 2021, which is a continuation of international No. PCT/CN2019/119763, filed on Nov. 20, 2019, which claims the priority to and benefits of International Patent Application No. PCT/CN2018/116371, filed on Nov. 20, 2018, International Patent Application No. PCT/CN2019/081155, filed on Apr. 2, 2019, and International Patent Application No. PCT/CN2019/085796, filed on May 7, 2019. For all purposes under the U.S. law, the entire disclosures of the aforementioned applications are incorporated by reference as part of the disclosure of this application.

### TECHNICAL FIELD

This disclosure is related to video and image coding and decoding technologies.

### BACKGROUND

Digital video accounts for the largest bandwidth use on the internet and other digital communication networks. As the number of connected user devices capable of receiving and displaying video increases, it is expected that the bandwidth demand for digital video usage will continue to grow.

### SUMMARY

In one example aspect, a method of processing video is disclosed. The method includes performing a conversion between a current block of visual media data and a corresponding coded representation of the visual media data, wherein the conversion of the current block includes determining whether a use of one or both of a bi-directional optical flow (BIO) technique or a decoder-side motion vector refinement (DMVR) technique to the current block is enabled or disabled, and wherein the determining the use of the BIO technique or the DMVR technique is based on a cost criterion associated with the current block.

In another example aspect, a method of processing video is disclosed. The method includes performing a conversion between a current block of visual media data and a corresponding coded representation of the visual media data, wherein the conversion of the current block includes determining whether a use of a decoder-side motion vector refinement (DMVR) technique to the current block is enabled or disabled, and wherein the DMVR technique includes refining motion information of the current block based on a cost criterion other than a mean removed sum of absolute differences (MRSAD) cost criterion.

In another example aspect, a method of processing video is disclosed. The method includes performing a conversion between a current block of visual media data and a corresponding coded representation of the visual media data, wherein the conversion of the current block includes determining whether a use of one or both of a bi-directional optical flow (BIO) technique or a decoder-side motion vector refinement (DMVR) technique to the current block is enabled or disabled, and wherein the determining the use of the BIO technique or the DMVR technique is based on computing that a mean value difference of a pair of reference blocks associated with the current block exceeds a threshold value.

In another example aspect, a method of processing video is disclosed. The method includes modifying a first reference block to generate a first modified reference block, and a second reference block to generate a second modified reference block, wherein both the first reference block and the second reference block are associated with a current block of visual media data; determining differences between the first modified reference block and the second modified reference block, the differences including one or more of: a sum of absolute transformed differences (SATD), a mean removed sum of absolute transformed differences (MRSATD), a sum of squares error (SSE), a mean removed sum of squares error (MRSSE), a mean value difference, or gradient values; and performing a conversion between the current block of visual media data and a corresponding coded representation of the visual media data, wherein the conversion includes a use of the differences between the first modified reference block and the second modified reference block generated from respectively modifying the first reference block and the second reference block.

In another example aspect, a method of processing video is disclosed. The method includes determining a temporal gradient or a modified temporal gradient using reference pictures associated with a current block of visual media data, the temporal gradient or the modified temporal gradient indicative of differences between the reference pictures; and performing a conversion between the current block of visual media data and a corresponding coded representation of the visual media data, wherein the conversion includes a use of a bi-directional optical flow (BIO) technique based in part on the temporal gradient or the modified temporal gradient.

In another example aspect, a method of processing video is disclosed. The method includes determining a first temporal gradient using reference pictures associated with a first video block or a sub-block thereof; determining a second temporal gradient using reference pictures associated with a second video block or a sub-block thereof; performing a modification of the first temporal gradient and a modification of the second temporal gradient to generate a modified first temporal gradient and a modified second temporal gradient, wherein the modification of the first temporal gradient associated with the first video block is different from the modification of the second temporal gradient associated with the second video block; and performing a conversion of the first video block and the second video block to their corresponding coded representation.

In another example aspect, a method of processing video is disclosed. The method includes modifying one or both of a first inter reference block and a second inter reference block associated with a current block; determining, based on using the one or both modified first inter reference block and/or the modified second inter reference block, a spatial gradient associated with the current block in accordance with applying a bi-directional optical (BIO) flow technique; and performing a conversion between the current block and a corresponding coded representation, wherein the conversion includes a use of the spatial gradient associated with the current block.

In another example aspect, a method of processing video is disclosed. The method includes performing a determination, by a processor, that a flag which can be signaled at multiple levels indicates, at least in part, that one or both of a decoder-side motion vector refinement (DMVR) technique or a bi-directional optical flow (BIO) technique is to be enabled for a current block; and performing a conversion between the current block and a corresponding coded representation, wherein the coded representation includes the flag indicating whether the one or both of the DMVR technique and/or the BIO technique is enabled.

In another example aspect, a method of processing video is disclosed. The method includes performing a determination, by a processor that a decoder-side motion vector refinement (DMVR) technique is to be enabled for a current block, wherein the determination is based exclusively on a height of the current block; and performing a conversion between the current block and a corresponding coded representation.

In another example aspect, a method of processing video is disclosed. The method includes performing a conversion between a current block of visual media data and a corresponding coded representation of visual media data, wherein the conversion includes a use of rules associated with one or both of a decoder-side motion vector refinement (DMVR) technique or a bi-directional optical flow (BIO) technique on the current block, wherein the rules associated with the DMVR technique are consistent with application to the BIO technique; and wherein determining whether the use of the one or both of the BIO technique or the DMVR technique on the current block is enabled or disabled is based on applying the rules.

In another example aspect, the above-described methods may be implemented by a video decoder apparatus that comprises a processor.

In another example aspect, the above-described methods may be implemented by a video encoder apparatus that comprises a processor.

In yet another example aspect, these methods may be embodied in the form of processor-executable instructions and stored on a computer-readable program medium.

These, and other, aspects are further described in the present disclosure.

### BRIEF DESCRIPTION OF THE DRAWINGS

FIG. 1 shows an example of bilateral matching.

FIG. 2 shows an example of template matching.

FIG. 3 shows an example of unilateral motion estimation (ME) in Frame-Rate Up Conversion (FRUC).

FIG. 4 shows an example of optical flow trajectory.

FIGS. 5A and 5B show examples of bi-directional optical flow (BIO) without block extension.

FIG. 6 shows an example of bilateral matching with 6 points search.

FIG. 7 shows examples of an adaptive integer search pattern and a half sample search pattern.

FIG. 8 is a block diagram of an example of a video processing apparatus.

FIG. 9 shows a block diagram of an example implementation of a video encoder.

FIG. 10 is a flowchart for an example of a video processing method.

FIG. 11 is a flowchart for an example of a video processing method.

FIG. 12 is a flowchart for an example of a video processing method.

FIG. 13 is a flowchart for an example of a video processing method.

FIG. 14 is a flowchart for an example of a video processing method.

FIG. 15 is a flowchart for an example of a video processing method.

FIG. 16 is a flowchart for an example of a video processing method.

FIG. 17 is a block diagram of an example video processing system in which disclosed techniques may be implemented.

FIG. 18 is a flowchart for an example of a video processing method.

FIG. 19 is a flowchart for an example of a video processing method.

FIG. 20 is a flowchart for an example of a video processing method.

FIG. 21 is a flowchart for an example of a video processing method.

FIG. 22 is a flowchart for an example of a video processing method.

FIG. 23 is a flowchart for an example of a video processing method.

FIG. 24 is a flowchart for an example of a video processing method.

FIG. 25 is a flowchart for an example of a video processing method.

FIG. 26 is a flowchart for an example of a video processing method.

FIG. 27 is a flowchart for an example of a video processing method.

### DETAILED DESCRIPTION

To improve compression ratio of video, researchers are continually looking for new techniques by which to encode video. The present disclosure provides various techniques that can be used by a decoder of video bitstreams to improve the quality of decompressed or decoded digital video. Furthermore, a video encoder may also implement these techniques during the process of encoding in order to reconstruct decoded frames used for further encoding.

Section headings are used in the present disclosure for improving readability and do not limit the scope of techniques and embodiments described in each section only to that section. Furthermore, while certain terms from various existing video codec standards are used, the disclosed technologies are not limited only to these video standards or their successors and are applicable to other video codec standards. Furthermore, in some cases, techniques are disclosed using corresponding coding steps, and it will be understood that, at a decoder, the corresponding decoding steps in reverse order will be performed. In addition, coding may also be used to perform transcoding in which a video is represented from one coded representation (e.g., one bitrate) to another coded representation (e.g., a different bitrate).

### 1. Summary

The present disclosure is related to video coding technologies. Specifically, it is related to motion compensation in video coding. It may be applied to the existing video coding standard like High Efficiency Video Coding (HEVC), or the standard Versatile Video Coding (VVC) to be finalized. It may be also applicable to future video coding standards or video codec.

### 2. Background

Video coding standards have evolved primarily through the development of the well-known International Telecommunication Union-Telecommunication (ITU-T) and International Organization for Standardization (ISO)/International Electrotechnical Commission (IEC) standards. The ITU-T produced H.261 and H.263, ISO/IEC produced Moving Picture Experts Group (MPEG)-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by Video Coding Experts Group (VCEG) and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC Joint Telecommunications Committee (JTC1) sub-committee (SC) 29/working group (WG) 11 (MPEG) was created to work on the VVC standard targeting at 50% bitrate reduction compared to HEVC.

The latest version of VVC draft, i.e., Versatile Video Coding (Draft 2) could be found at:
http://phenix.it-sudparis.eu/jvet/doc_end_user/documents/11_Ljubljana/wg11/JVET-K1001-v7.zip. The latest
   reference software of VVC, named VTM, could be found at:
https://vcgit.hhi.fraunhofer.de/jvet/VVCSoftware_VTM/tags/VTM-2.1.

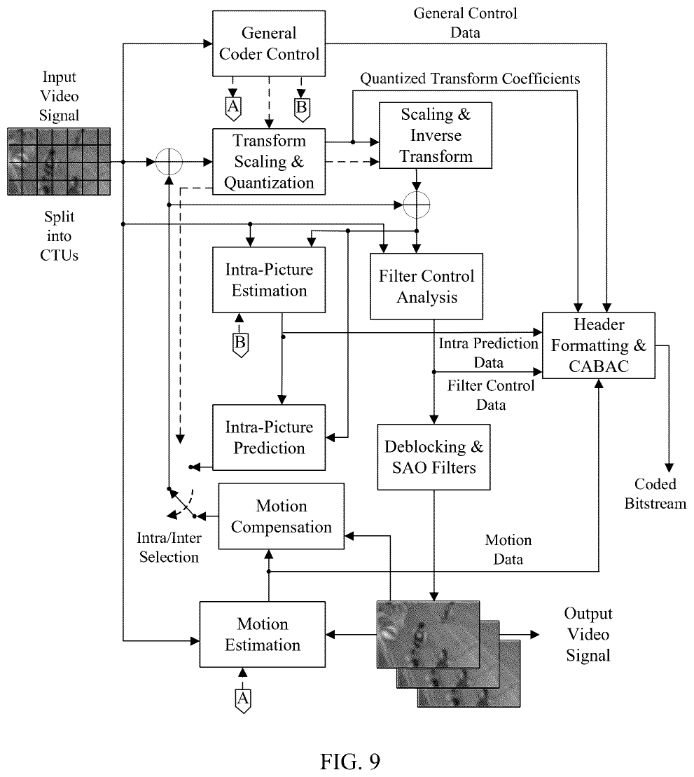

FIG. 9 is a block diagram of an example implementation of a video encoder. FIG. 9 shows that the encoder implementation has a feedback path built in in which the video encoder also performs video decoding functionality (reconstructing compressed representation of video data for use in encoding of next video data).

### 2.1 Pattern Matched Motion Vector Derivation

Pattern matched motion vector derivation (PMMVD) mode is a special merge mode based on Frame-Rate Up Conversion (FRUC) techniques. With this mode, motion information of a block is not signalled but derived at decoder side.

A FRUC flag is signalled for a coding unit (CU) when its merge flag is true. When the FRUC flag is false, a merge index is signalled and the regular merge mode is used. When the FRUC flag is true, an additional FRUC mode flag is signalled to indicate which method (bilateral matching or template matching) is to be used to derive motion information for the block.

At encoder side, the decision on whether using FRUC merge mode for a CU is based on rate distortion (RD) cost selection as done for normal merge candidate. That is the two matching modes (bilateral matching and template matching) are both checked for a CU by using RD cost selection. The one leading to the minimal cost is further compared to other CU modes. If a FRUC matching mode is the most efficient one, FRUC flag is set to true for the CU and the related matching mode is used.

Motion derivation process in FRUC merge mode has two steps. A CU-level motion search is first performed, then followed by a Sub-CU level motion refinement. At CU level, an initial motion vector is derived for the whole CU based on bilateral matching or template matching. First, a list of motion vector (MV) candidates is generated and the candidate which leads to the minimum matching cost is selected as the starting point for further CU level refinement. Then a local search based on bilateral matching or template matching around the starting point is performed and the MV results in the minimum matching cost is taken as the MV for the whole CU. Subsequently, the motion information is further refined at sub-CU level with the derived CU motion vectors as the starting points.

For example, the following derivation process is performed for a W×H CU motion information derivation. At the first stage, MV for the whole W×H CU is derived. At the second stage, the CU is further split into M×M sub-CUs. The value of M is calculated as in (16), D is a predefined splitting depth which is set to 3 by default in the JEM. Then the MV for each sub-CU is derived as:

$$M = max \{ 4 , min \{ \frac{M}{{2}^{D}} , \frac{N}{{2}^{D}} \} \} \qquad ( 1 )$$

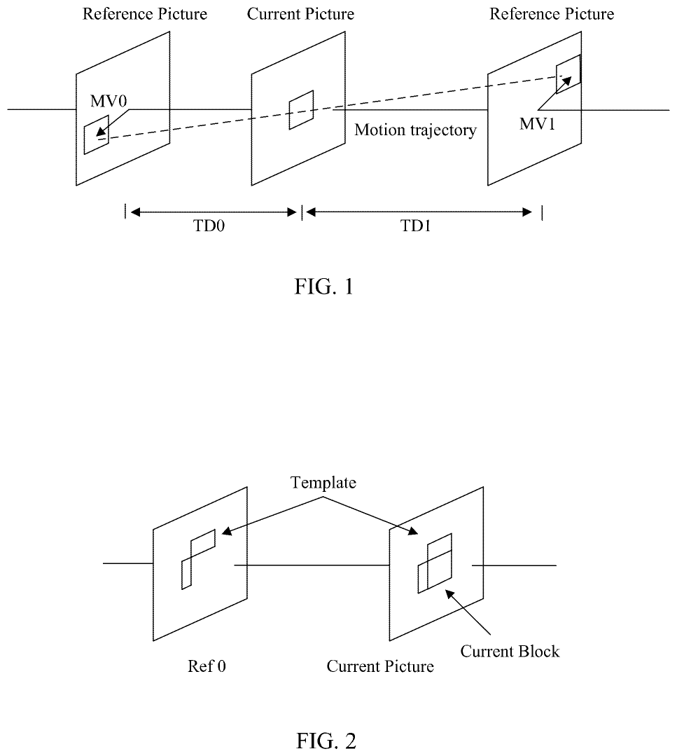

As shown in FIG. 1, the bilateral matching is used to derive motion information of the current CU by finding the closest match between two blocks along the motion trajectory of the current CU in two different reference pictures. Under the assumption of continuous motion trajectory, the motion vectors MV0 and MV1 pointing to the two reference blocks shall be proportional to the temporal distances, i.e., TD0 and TD1, between the current picture and the two reference pictures. As a special case, when the current picture is temporally between the two reference pictures and the temporal distance from the current picture to the two reference pictures is the same, the bilateral matching becomes mirror based bi-directional MV.

As shown in FIG. 2, template matching is used to derive motion information of the current CU by finding the closest match between a template (top and/or left neighbouring blocks of the current CU) in the current picture and a block (same size to the template) in a reference picture. Except the aforementioned FRUC merge mode, the template matching is also applied to advanced motion vector prediction (AMVP) mode. In the JEM, as done in HEVC, AMVP has two candidates. With template matching method, a new candidate is derived. If the newly derived candidate by template matching is different to the first existing AMVP candidate, it is inserted at the very beginning of the AMVP candidate list and then the list size is set to two (meaning remove the second existing AMVP candidate). When applied to AMVP mode, only CU level search is applied.

### CU Level MV Candidate Set

The MV candidate set at CU level can include:
Original AMVP candidates if the current CU is in AMVP mode,
all merge candidates,.
several MVs in the interpolated MV field, which is introduced in section 2.1.1.3, and
top and left neighbouring motion vectors

When using bilateral matching, each valid MV of a merge candidate is used as an input to generate a MV pair with the assumption of bilateral matching. For example, one valid MV of a merge candidate is (MVa, refa) at reference list A. Then the reference picture refb of its paired bilateral MV is found in the other reference list B so that refa and refb are temporally at different sides of the current picture. If such a refb is not available in reference list B, refb is determined as a reference which is different from refa and its temporal distance to the current picture is the minimal one in list B. After refb is determined, MVb is derived by scaling MVa based on the temporal distance between the current picture and refa, refb.

Four MVs from the interpolated MV field are also added to the CU level candidate list. More specifically, the interpolated MVs at the position (0, 0), (W/2, 0), (0, H/2) and (W/2, H/2) of the current CU are added.

When FRUC is applied in AMVP mode, the original AMVP candidates are also added to CU level MV candidate set.

At the CU level, up to 15 MVs for AMVP CUs and up to 13 MVs for merge CUs are added to the candidate list.

### Sub-CU Level MV Candidate Set

The MV candidate set at sub-CU level can include:
an MV determined from a CU-level search,
top, left, top-left and top-right neighbouring MVs,
scaled versions of collocated MVs from reference pictures,
up to 4 ATMVP candidates, and
up to 4 spatial-temporal motion vector predictor (STMVP) candidates.

The scaled MVs from reference pictures are derived as follows. All the reference pictures in both lists are traversed. The MVs at a collocated position of the sub-CU in a reference picture are scaled to the reference of the starting CU-level MV.

ATMVP and STMVP candidates are limited to the four first ones.

At the sub-CU level, up to 17 MVs are added to the candidate list.

### Generation of Interpolated MV Field

Before coding a frame, interpolated motion field is generated for the whole picture based on unilateral ME. Then the motion field may be used later as CU level or sub-CU level MV candidates.

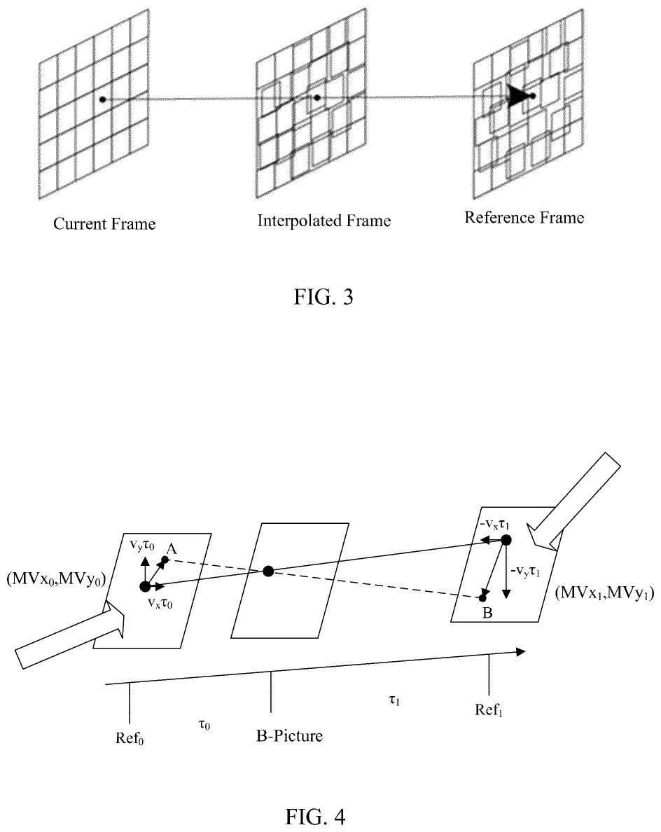

First, the motion field of each reference pictures in both reference lists is traversed at 4×4 block level. For each 4×4 block, if the motion associated to the block passing through a 4×4 block in the current picture (as shown in FIG. 3) and the block has not been assigned any interpolated motion, the motion of the reference block is scaled to the current picture according to the temporal distance TD0 and TD1 (the same way as that of MV scaling of TMVP in HEVC) and the scaled motion is assigned to the block in the current frame. If no scaled MV is assigned to a 4×4 block, the block's motion is marked as unavailable in the interpolated motion field.

### Interpolation and Matching Cost

When a motion vector points to a fractional sample position, motion compensated interpolation can be performed. To reduce complexity, bi-linear interpolation instead of regular 8-tap HEVC interpolation is used for both bilateral matching and template matching.

The calculation of matching cost is a bit different at different steps. When selecting the candidate from the candidate set at the CU level, the matching cost is the absolute sum difference (SAD) of bilateral matching or template matching. After the starting MV is determined, the matching cost C of bilateral matching at sub-CU level search is calculated as follows:

$$C = S A D + w \cdot ( \vert {MV}_{x} - M {V}_{x}^{s} \vert + \vert {MV}_{y} - M {V}_{y}^{s} \vert ) \qquad ( 2 )$$

where w is a weighting factor which is empirically set to 4, MV and MV^{s} indicate the current MV and the starting MV, respectively. SAD is still used as the matching cost of template matching at sub-CU level search.

In FRUC mode, MV is derived by using luma samples only. The derived motion will be used for both luma and chroma for MC inter prediction. After MV is decided, final motion compensation (MC) is performed using 8-taps interpolation filter for luma and 4-taps interpolation filter for chroma.

### MV Refinement

MV refinement is a pattern based MV search with the criterion of bilateral matching cost or template matching cost. In the JEM, two search patterns are supported—an unrestricted center-biased diamond search (UCBDS) and an adaptive cross search for MV refinement at the CU level and sub-CU level, respectively. For both CU and sub-CU level MV refinement, the MV is directly searched at quarter luma sample MV accuracy, and this is followed by one-eighth luma sample MV refinement. The search range of MV refinement for the CU and sub-CU step are set equal to 8 luma samples.

### Selection of Prediction Direction in Template Matching FRUC Merge Mode

In the bilateral matching merge mode, bi-prediction is always applied since the motion information of a CU is derived based on the closest match between two blocks along the motion trajectory of the current CU in two different reference pictures. There is no such limitation for the template matching merge mode. In the template matching merge mode, the encoder can choose among uni-prediction from list0, uni-prediction from list1 or bi-prediction for a CU. The selection is based on a template matching cost as follows:

```
If costBi <= factor * min (cost0, cost1)
  bi-prediction is used;
Otherwise, if cost0 <= cost1
  uni-prediction from list0 is used;
Otherwise,
  uni-prediction from list1 is used;
```

where cost0 is the SAD of list0 template matching, cost1 is the SAD of list1 template matching and costBi is the SAD of bi-prediction template matching. The value of factor is equal to 1.25, which means that the selection process is biased toward bi-prediction.

The inter prediction direction selection is only applied to the CU-level template matching process.

### Hybrid Intra and Inter Prediction

In JVET-L0100, multi-hypothesis prediction is proposed, wherein hybrid intra and inter prediction is one way to generate multiple hypotheses.

When the multi-hypothesis prediction is applied to improve intra mode, multi-hypothesis prediction combines one intra prediction and one merge indexed prediction. In a merge CU, one flag is signaled for merge mode to select an intra mode from an intra candidate list when the flag is true. For luma component, the intra candidate list is derived from 4 intra prediction modes including direct current (DC), planar, horizontal, and vertical modes, and the size of the intra candidate list can be 3 or 4 depending on the block shape. When the CU width is larger than the double of CU height, horizontal mode is exclusive of the intra mode list and when the CU height is larger than the double of CU width, vertical mode is removed from the intra mode list. One intra prediction mode selected by the intra mode index and one merge indexed prediction selected by the merge index are combined using weighted average. For chroma component, direct mode (DM) is always applied without extra signaling. The weights for combining predictions are described as follow. When DC or planar mode is selected, or the CB width or height is smaller than 4, equal weights are applied. For those CBs with CB width and height larger than or equal to 4, when horizontal/vertical mode is selected, one CB is first vertically/horizontally split into four equal-area regions. Each weight set, denoted as (w_intrai, w_interi), where i is from 1 to 4 and (w_intra₁, w_inter₁)=(6, 2), (w_intra₂, w_inter₂)=(5, 3), (w_intra₃, w_inter₃)=(3, 5), and (w_intra₄, w_inter₄)=(2, 6), will be applied to a corresponding region. (w_intra₁, w_inter₁) is for the region closest to the reference samples and (w_intra₄, w_inter₄) is for the region farthest away from the reference samples. Then, the combined prediction can be calculated by summing up the two weighted predictions and right-shifting 3 bits. Moreover, the intra prediction mode for the intra hypothesis of predictors can be saved for reference of the following neighboring CUs.

### Bi-Directional Optical Flow

In BIO, motion compensation is first performed to generate the first predictions (in each prediction direction) of the current block. The first predictions are used to derive the spatial gradient, the temporal gradient and the optical flow of each subblock/pixel within the block, which are then used to generate the second prediction, i.e., the final prediction of the subblock/pixel. The details are described as follows.

Bi-directional Optical flow (BIO) is sample-wise motion refinement which is performed on top of block-wise motion compensation for bi-prediction. The sample-level motion refinement doesn't use signalling.

Let I^{(k)} be the luma value from reference k (k=0, 1) after block motion compensation, and δI^{(k)}/δx, δI^{(k)}/δy are horizontal and vertical components of the I^{(k)} gradient, respectively. Assuming the optical flow is valid, the motion vector field (Vₓ, V_{y}) is given by the equation:

$$\partial {I}^{( k )} / \partial t + {v}_{x} \partial {I}^{( k )} / \partial x + {v}_{y} \partial {I}^{( k )} / \partial y = 0. \qquad ( 3 )$$

Combining this optical flow equation with Hermite interpolation for the motion trajectory of each sample results in a unique third-order polynomial that matches both the function values I^{(k)} and derivatives δI^{(k)}/δx, δI^{(k)}/δy at the ends. The value of this polynomial at t=0 is the BIO prediction:

$$p r e {d}_{BIO} = 1 / 2 \cdot ( {I}^{( 0 )} + {I}^{( 1 )} + {v}_{x} / 2 \cdot ( {τ}_{1} \partial {I}^{( 1 )} / \partial x - {τ}_{0} \partial {I}^{( 0 )} / \partial x ) + {v}_{y} / 2 \cdot ( {τ}_{1} \partial {I}^{( 1 )} / \partial y - {τ}_{0} \partial {I}^{( 0 )} / \partial y ) ) . \qquad ( 4 )$$

Here, τ₀ and τ₁, denote the distances to the reference frames as shown on FIG. 4. Distances τ₀ and τ₁are calculated based on picture order count (POC) for Ref0 and Ref1: τ₀=POC (current)−POC (Ref0), τ₁=POC (Ref1)−POC(current). If both predictions come from the same time direction (either both from the past or both from the future) then the signs are different (i.e., τ₀·τ₁<0). In this case, BIO is applied only if the prediction is not from the same time moment (i.e., τ₀≠τ₁), both referenced regions have non-zero motion (MVx₀, MVy₀, MVx₁, MVy₁≠0) and the block motion vectors are proportional to the time distance (MVx₀/MVx₁=MVy₀/MVy₁=−τ₀/τ₁).

The motion vector field (Vₓ, V_{y}) is determined by minimizing the difference Δ between values in points A and B (intersection of motion trajectory and reference frame planes on FIG. 9). Model uses only first linear term of a local Taylor expansion for Δ as:

$$Δ = ( {I}^{( 0 )} - {I}_{0}^{( 1 )} + {v}_{x} ( {τ}_{1} \partial {I}^{( 1 )} / \partial x + {τ}_{0} \partial {I}^{( 0 )} / \partial x ) + {v}_{y} ( {τ}_{1} \partial {I}^{( 1 )} / \partial γ + {τ}_{0} \partial {I}^{( 0 )} / \partial γ ) ) \qquad ( 5 )$$

All values in Equation 5 depend on the sample location (i′, j′), which was omitted from the notation so far. Assuming the motion is consistent in the local surrounding area, the value of Δ can be minimized inside the (2M+1)×(2M+1) square window Ω centered on the currently predicted point (i, j), where M is equal to 2:

$$( {v}_{x} , {v}_{y} ) = {arg min}_{{v}_{x} , {v}_{y}} {\sum }_{[ {i}^{′} , j ] ∈ Ω} {Δ}^{2} [ {i}^{′} , {j}^{′} ] \qquad ( 6 )$$

For this optimization problem, the JEM uses a simplified approach making first a minimization in the vertical direction and then in the horizontal direction. This results in

$${v}_{x} = ( {s}_{1} + r ) > m ? clip 3 ( - thBIO , thBIO , - \frac{{s}_{3}}{( {s}_{1} + r )} ) : 0 \qquad ( 7 )$$

$${v}_{y} = ( {s}_{5} + r ) > m ? clip 3 ( - thBIO , thBIO , - \frac{{s}_{6} - {v}_{x} {s}_{2} / 2}{( {s}_{5} + r )} ) : 0 \qquad ( 8 )$$

$$where ,$$

$${s}_{1} = {\sum }_{[ {i}^{′} , j ] ∈ Ω} {( {τ}_{1} \partial {I}^{( 1 )} / \partial x + {τ}_{0} \partial {I}^{( 0 )} / \partial x )}^{2} ; \qquad ( 9 )$$

$${s}_{3} = {\sum }_{[ {i}^{′} , j ] ∈ Ω} ( {I}^{( 1 )} - {I}^{( 0 )} ) ( {τ}_{1} \partial {I}^{( 1 )} / \partial x + {τ}_{0} \partial {I}^{( 0 )} / \partial x ) ;$$

$${s}_{2} = {\sum }_{[ {i}^{′} , j ] ∈ Ω} ( {τ}_{1} \partial {I}^{( 1 )} / \partial x + {τ}_{0} \partial {I}^{( 0 )} / \partial x ) ( {τ}_{1} \partial {I}^{( 1 )} / \partial y + {τ}_{0} \partial {I}^{( 0 )} / \partial y ) ;$$

$${s}_{5} = {\sum }_{[ {i}^{′} , j ] ∈ Ω} {( {τ}_{1} \partial {I}^{( 1 )} / \partial y + {τ}_{0} \partial {I}^{( 0 )} / \partial y )}^{2} ;$$

$${s}_{6} = {\sum }_{[ {i}^{′} , j ] ∈ Ω} ( {I}^{( 1 )} - {I}^{( 0 )} ) ( {τ}_{1} \partial {I}^{( 1 )} / \partial y + {τ}_{0} \partial {I}^{( 0 )} / \partial y )$$

In order to avoid division by zero or a very small value, regularization parameters r and m are introduced in Equations 7 and 8 where:

$$r = 500 \cdot {4}^{d - 8} \qquad ( 10 )$$

$$m = 700 \cdot {4}^{d - 8} \qquad ( 11 )$$

Here d is bit depth of the video samples.

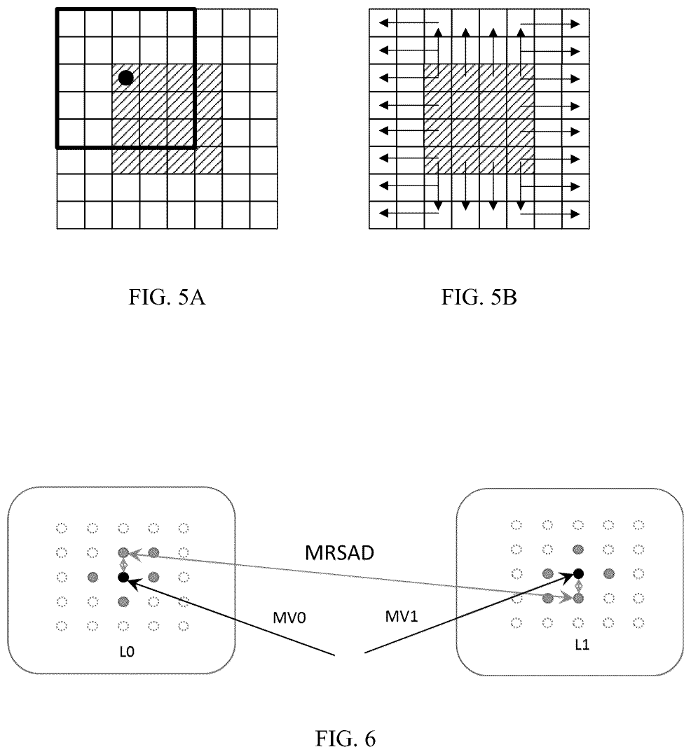

In order to keep the memory access for BIO the same as for regular bi-predictive motion compensation, all prediction and gradients values, I^{(k)}, δI^{(k)}/δx, δI^{(k)}/δy, are calculated only for positions inside the current block. In Equation 9, (2M+1)×(2M+1) square window Ω centered in currently predicted point on a boundary of predicted block can access positions outside of the block (as shown in FIG. 5A). In the JEM, values of I^{(k)}, δI^{(k)}/δx, δI^{(k)}/δy outside of the block are set to be equal to the nearest available value inside the block. For example, this can be implemented as padding, as shown in FIG. 5B.

With BIO, it is possible that the motion field can be refined for each sample. To reduce the computational complexity, a block-based design of BIO is used in the JEM. The motion refinement is calculated based on 4×4 block. In the block-based BIO, the values of sn in Equation 9 of all samples in a 4×4 block are aggregated, and then the aggregated values of sn in are used to derived BIO motion vectors offset for the 4×4 block. More specifically, the following formula is used for block-based BIO derivation:

$${s}_{1 , {b}_{k}} = {\sum }_{( x , y ) ∈ {b}_{k}} {\sum }_{[ {i}^{′} , j ] ∈ Ω ( x , y )} {( {τ}_{1} \partial {I}^{( 1 )} / \partial x + {τ}_{0} \partial {I}^{( 0 )} / \partial x )}^{2} ; \qquad ( 12 )$$

$${s}_{3 , {b}_{k}} = {\sum }_{( x , y ) ∈ {b}_{k}} {\sum }_{[ {i}^{′} , j ] ∈ Ω} ( {I}^{( 1 )} - {I}^{( 0 )} ) ( {τ}_{1} \partial {I}^{( 1 )} / \partial x + {τ}_{0} \partial {I}^{( 0 )} / \partial x ) ;$$

$${s}_{2 , {b}_{k}} = {\sum }_{( x , y ) ∈ {b}_{k}} {\sum }_{[ {i}^{′} , j ] ∈ Ω} ( {τ}_{1} \partial {I}^{( 1 )} / \partial x + {τ}_{0} \partial {I}^{( 0 )} / \partial x ) ( {τ}_{1} \partial {I}^{( 1 )} / \partial y + {τ}_{0} \partial {I}^{( 0 )} / \partial y ) ;$$

$${s}_{5 , {b}_{k}} = {\sum }_{( x , y ) ∈ {b}_{k}} {\sum }_{[ {i}^{′} , j ] ∈ Ω} {( {τ}_{1} \partial {I}^{( 1 )} / \partial y + {τ}_{0} \partial {I}^{( 0 )} / \partial y )}^{2} ;$$

$${s}_{6 , {b}_{k}} = {\sum }_{( x , u ) ∈ {b}_{k}} {\sum }_{[ {i}^{′} , j ] ∈ Ω} ( {I}^{( 1 )} - {I}^{( 0 )} ) ( {τ}_{1} \partial {I}^{( 1 )} / \partial y + {τ}_{0} \partial {I}^{( 0 )} / \partial y )$$

where bₖ denotes the set of samples belonging to the k-th 4×4 block of the predicted block. Sₙ in Equations 7 and 8 are replaced by ((Sₙ,bₖ)>>4) to derive the associated motion vector offsets.

In some cases, MV regiment of BIO might be unreliable due to noise or irregular motion. Therefore, in BIO, the magnitude of MV regiment is clipped to a threshold value thBIO. The threshold value is determined based on whether the reference pictures of the current picture are all from one direction. If all the reference pictures of the current picture are from one direction, the value of the threshold is set to 12×2^{14-d}; otherwise, it is set to 12×213^{-d}.

Gradients for BIO are calculated at the same time with motion compensation interpolation using operations consistent with HEVC motion compensation process (two dimensional (2D) separable finite impulse response (FIR)). The input for this 2D separable FIR is the same reference frame sample as for motion compensation process and fractional position (fracX, fracY) according to the fractional part of block motion vector. In case of horizontal gradient δI/δx signal first interpolated vertically using BIOfilterS corresponding to the fractional position fracY with de-scaling shift d-8, then gradient filter BIOfilterG is applied in horizontal direction corresponding to the fractional position fracX with de-scaling shift by 18−d. In case of vertical gradient δI/δy first gradient filter is applied vertically using BIOfilterG corresponding to the fractional position fracY with de-scaling shift d−8, then signal displacement is performed using BIOfilterS in horizontal direction corresponding to the fractional position fracX with de-scaling shift by 18−d. The length of interpolation filter for gradients calculation BIOfilterG and signal displacement BIOfilterF is shorter (6-tap) in order to maintain reasonable complexity. Table 1 shows the filters used for gradients calculation for different fractional positions of block motion vector in BIO. Table 2 shows the interpolation filters used for prediction signal generation in BIO.

TABLE 1
Filters for gradients calculation in BIO

| Fractional | Interpolation filter for |
|---|---|
| pel position | gradient(BIOfilterG) |
| 0 | { 8, −39, −3, 46, −17, 5} |
| 1/16 | { 8, −32, −13, 50, −18, 5} |
| ⅛ | { 7, −27, −20, 54, −19, 5} |
| 3/16 | { 6, −21, −29, 57, −18, 5} |
| ¼ | { 4, −17, −36, 60, −15, 4} |
| 5/16 | { 3, −9, −44, 61, −15, 4} |
| ⅜ | { 1, −4, −48, 61, −13, 3} |
| 7/16 | { 0, 1, −54, 60, −9, 2} |
| ½ | { −1, 4, −57, 57, −4, 1} |

TABLE 2
Interpolation filters for prediction signal generation in BIO

| Fractional | Interpolation filter for |
|---|---|
| pel position | prediction signal(BIOfilterS) |
| 0 | { 0, 0, 64, 0, 0, 0} |
| 1/16 | { 1, −3, 64, 4, −2, 0} |
| ⅛ | { 1, −6, 62, 9, −3, 1} |
| 3/16 | { 2, −8, 60, 14, −5, 1} |
| ¼ | { 2, −9, 57, 19, −7, 2} |
| 5/16 | { 3, −10, 53, 24, −8, 2} |
| ⅜ | { 3, −11, 50, 29, −9, 2} |
| 7/16 | { 3, −11, 44, 35, −10, 3} |
| ½ | { 3, −10, 35, 44, −11, 3} |

In the JEM, BIO is applied to all bi-predicted blocks when the two predictions are from different reference pictures. When local illumination compensation (LIC) is enabled for a CU, BIO is disabled.

In the JEM, overlapped block motion compensation (OBMC) is applied for a block after normal MC process. To reduce the computational complexity, BIO is not applied during the OBMC process. This means that BIO is only applied in the MC process for a block when using its own MV and is not applied in the MC process when the MV of a neighboring block is used during the OBMC process.

A two-stage early termination method is used to conditionally disable the BIO operations depending on the similarity between the two prediction signals. The early termination is first applied at the CU-level and then at the sub-CU-level. Specifically, the proposed method first calculates the SAD between the L0 and L1 prediction signals at the CU level. Given that the BIO is only applied to luma, only the luma samples can be considered for the SAD calculation. If the CU-level SAD is no larger than a predefined threshold, the BIO process is completely disabled for the whole CU. The CU-level threshold is set to 2^{(BDepth-9)} per sample. If the BIO process is not disabled at the CU level, and if the current CU includes multiple sub-CUs, the SAD of each sub-CU inside the CU will be calculated. Then, the decision on whether to enable or disable the BIO process is made at the sub-CU-level based on a predefined sub-CU-level SAD threshold, which is set to 3*2^{(BDepth-10)} per sample.

### 2.4 Specification for Bi-Directional Optical Flow (BDOF) in VVC

Specification of BDOF (in JVET-N1001-v2) is as follows:

### 8.5.7.4 Bidirectional Optical Flow Prediction Process

Inputs to this process are:
two variables nCbW and nCbH specifying the width and the height of the current coding block,
two (nCbW+2)×(nCbH+2) luma prediction sample arrays predSamplesL0and predSamplesL1,
the prediction list utilization flags predFlagL0 and predFlagL1,
the reference indices refIdxL0 and refIdxL1,
the bidirectional optical flow utilization flags bdofUtilizationFlag[xIdx][yIdx] with xIdx=0 . . . (nCbW>>2)−1, yIdx=0 . . . (nCbH>>2)−1.

Output of this process is the (nCbW)×(nCbH) array pbSamples of luma prediction sample values.

Variables bitDepth, shift1, shift2, shift3, shift4, offset4, and mvRefineThres are derived as follows:
The variable bitDepth is set equal to BitDepth_{y}.
The variable shift1 is set to equal to Max(2, 14−bitDepth).
The variable shift2 is set to equal to Max(8, bitDepth−4).
The variable shift3 is set to equal to Max(5, bitDepth−7).
The variable shift4 is set equal to Max(3, 15−bitDepth) and the variable offset4 is set equal to 1<<(shift4−1).
The variable mvRefineThres is set equal to Max(2, 1<<(13−bitDepth)).

For xIdx=0 . . . (nCbW>>2)−1 and yIdx=0 . . . (nCbH>>2)−1, the following applies:
The variable xSb is set equal to (xIdx<<2)+1 and ySb is set equal to (yIdx<<2)+1.
If bdofUtilizationFlag[xSbIdx][yIdx] is equal to FALSE, for x=xSb−1 . . . xSb+2, y=ySb−1 . . . ySb+2, the prediction sample values of the current subblock are derived as follows:

$$pbSamples [ x ] [ y ] = Clip 3 ( 0 , ( {2}^{b i t D e p t h} ) - 1 , ( p r e d S a m p l esL 0 [ x + 1 ] [ y + 1 ] + offset 2 + predSamplesL 1 [ x + 1 ] [ y + 1 ] ) >> shift 2 \qquad ( 8 - 852 )$$

Otherwise (bdofUtilizationFlag[xSbIdx][yIdx] is equal to TRUE), the prediction sample values of the current subblock are derived as follows:
   For x=xSb−1 . . . xSb+4, y=ySb−1 . . . ySb+4, the following ordered steps apply:
      1. The locations (hₓ, V_{y}) for each of the corresponding sample locations (x, y) inside the prediction sample arrays are derived as follows:

$${h}_{x} = C lip 3 ( 1 , nCbW , x ) \qquad ( 8 - 853 )$$

$${v}_{y} = C lip 3 ( 1 , nCbH , y ) \qquad ( 8 - 854 )$$

2. The variables gradientHL0[x][y], gradient VL₀[x][y], gradient HL1[x][y] and gradientVL1[x][y] are derived as follows:

$$gradientHL 0 [ x ] [ y ] = ( predSampleL 0 [ {h}_{x} + 1 ] [ {v}_{y} ] - predSampleL 0 [ {h}_{x} - 1 ] [ {v}_{y} ] ) >> shift 1 \qquad ( 8 - 855 )$$

$$gradientVL 0 [ x ] [ y ] = ( predSampleL 0 [ {h}_{x} ] [ {v}_{y} + 1 ] - predSampleL 0 [ {h}_{x} ] [ {v}_{y} - 1 ] ) >> shift 1 \qquad ( 8 - 856 )$$

$$gradientHL 1 [ x ] [ y ] = ( predSampleL 1 [ {h}_{x} + 1 ] [ {v}_{y} ] - predSampleL 1 [ {h}_{x} - 1 ] [ {v}_{y} ] ) >> shift 1 \qquad ( 8 - 857 )$$

$$gradientVL 1 [ x ] [ y ] = ( predSampleL 1 [ {h}_{x} ] [ {v}_{y} + 1 ] - predSampleL 1 [ {h}_{x} ] [ {v}_{y} - 1 ] ) >> shift 1 \qquad ( 8 - 858 )$$

3. The variables temp[x][y], tempH[x][y] and tempV[x][y] are derived as follows:

$$diff [ x ] [ y ] = ( predSamplesL 0 [ {h}_{x} ] [ {v}_{y} ] >> shift 2 ) - ( predSamplesL 1 [ {h}_{x} ] [ {v}_{y} ] >> shift 2 ) \qquad ( 8 - 859 )$$

$$tempH [ x ] [ y ] = ( gradientHL 0 [ x ] [ y ] + gradientHL 1 [ x ] [ y ] ) >> shift 3 \qquad ( 8 - 860 )$$

$$tempV [ x ] [ y ] = ( gradientVL 0 [ x ] [ y ] + gradientVL 1 [ x ] [ y ] ) >> shift 3 \qquad ( 8 - 861 )$$

The variables sGx2, sGy2, sGxGy, sGxdI and sGydI are derived as follows:

$$sGx 2 = {Σ}_{i} {Σ}_{j} ( t empH [ xS b + i ] [ y S b + j ] * temp H [ x S b + i ] [ y S b + j ] ) \qquad ( 8 - 862 )$$

$$with i , j = - 1 … 4$$

$$sGy 2 = {Σ}_{i} {Σ}_{j} ( tempV [ xSb + i ] [ y S b + j ] * tempV [ xSb + i ] [ y S b + j ] ) \qquad ( 8 - 863 )$$

$$with i , j = - 1 … 4$$

$$sGyGy = {Σ}_{i} {Σ}_{j} ( tempH [ xSb + i ] [ y S b + j ] * tempV [ xSb + i ] [ y S b + j ] ) \qquad ( 8 - 864 )$$

$$with i , j = - 1 … 4$$

$$sGxdI = {Σ}_{i} {Σ}_{j} ( - tempH [ xS b + i ] [ y S b + j ] * dif f [ x S b + i ] [ y S b + j ] ) \qquad ( 8 - 865 )$$

$$with i , j = - 1 … 4$$

$$sGydI = {Σ}_{i} {Σ}_{j} ( - tempV [ xSb + i ] [ y S b + j ] * dif f [ x S b + i ] [ y S b + j ] ) \qquad ( 8 - 866 )$$

$$with i , j = - 1 … 4$$

The horizontal and vertical motion offset of the current subblock are derived as:

$${v}_{x} = sGx 2 > 0 ? Clip 3 ( - mvRefineThres , mvRefineThres , - ( sGxdI << 3 ) >> Floor ( Log 2 ( sGx 2 ) ) ) : 0 \qquad ( 8 - 867 )$$

$${v}_{y} = sGy 2 > 0 ? Clip 3 ( - mvRefineThres , mvRefineThres , ( ( sGydI << 3 ) - ( ( {v}_{x} * {sGxGy}_{m} ) << 12 + {v}_{x} * sGxGys ) >> 1 ) >> Floor ( Log 2 ( sGx 2 ) ) ) : 0 \qquad ( 8 - 868 )$$

For x=xSb−1 . . . xSb+2, y=ySb−1 . . . ySb+2, the prediction sample values of the current sub-block are derived as follows:

$$bdofOffset = Round ( ( {v}_{x} * ( gradientHL 1 [ x + 1 ] [ y + 1 ] - gradientHL 0 [ x + 1 ] [ y + 1 ] ) ) >> 1 ) + Round ( ( {v}_{y} * ( gradientVL 1 [ x + 1 ] [ y + 1 ] - gradientVL 0 [ x + 1 ] [ y + 1 ] ) ) >> 1 ) \qquad ( 8 - 869 )$$

$$pbSamples [ x ] [ y ] = Clip 3 ( 0 , ( {2}^{bitDepth} ) - 1 , ( predSamplesL 0 [ x + 1 ] [ y + 1 ] + offset 4 + predSamplesL 1 [ x + 1 ] [ y + 1 ] + bdofOffset ) >> shift 4 ) \qquad ( 8 - 870 )$$

The spatial gradient is calculated as follows:

$$gradientHL 0 [ x ] [ y ] = ( predSamplesL 0 [ {h}_{x} + 1 ] [ {v}_{y} ] - predSampleL 0 [ {h}_{x} - 1 ] [ {v}_{y} ] ) >> shift 1 \qquad ( 8 - 855 )$$

On the other hand, temporal gradient is calculated as follows:

$$diff [ x ] [ y ] = ( predSamplesL 0 [ {h}_{x} ] [ {v}_{y} ] >> shift 2 ) - ( predSamplesL 1 [ {h}_{x} ] [ {v}_{y} ] >> shift 2 ) \qquad ( 8 - 859 )$$

Thus, the calculation of spatial gradient and temporal gradient is not aligned.

### 2.5 Decoder-Side Motion Vector Refinement

In bi-prediction operation, for the prediction of one block region, two prediction blocks, formed using a motion vector (MV) of list0 and a MV of list1, respectively, are combined to form a single prediction signal. In JVET-K0217, the decoder-side motion vector refinement (DMVR) method, the two motion vectors of the bi-prediction are further refined by a bilateral matching process.

In the proposed method DMVR is applied only in Merge and Skip modes, if the following condition is true:

$$( POC - POC 0 ) * ( P O C - POC 1 ) < 0 ,$$

where POC is the picture order count of current to be encoded picture, POC0 and POC1 are picture order counts of the references for the current picture.

The signaled merge candidate pair is used as input to DMVR process and are denoted initial motion vectors (MV0, MV1). The search points that are searched by DMVR obey the motion vector difference mirroring condition. In other words any point that is checked by DMVR, denoted by candidate motion vector pair (MVO′, MV1′) obey the following two equations:

$$MV {0}^{′} = MV 0 + M {V}_{d i f f}$$

$$MV {1}^{′} = M V 1 - M {V}_{d i f f}$$

where MV_{diff} represents the points in the search space in one of the reference pictures.

After the construction of the search space the uni-lateral predictions are constructed using regular 8-tap DCTIF interpolation filter. Bilateral matching cost function is calculated by using mean removed sum of absolute differences (MRSAD) between the two predictions (FIG. 6) and the search point resulting in the minimum cost is selected as the refined MV pair. For the MRSAD calculation 16 bit precision of samples is used (which is the output of the interpolation filtering), and no clipping and no rounding operations are applied before MRSAD calculation. The reason for not applying rounding and clipping is to reduce internal buffer requirement.

FIG. 6 shows an example of bilateral matching with 6 points search.

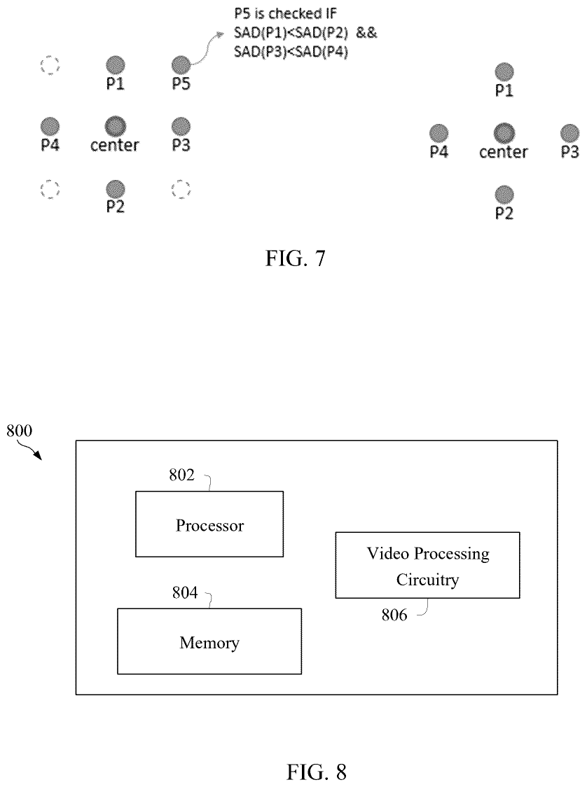

In the proposed method the integer precision search points are chosen by the Adaptive pattern method. The cost, corresponding to the central points (pointed by the initial motion vectors) is calculated firstly. The other 4 costs (in sign shape) is calculated by the two predictions, located at the opposite sides of each other by the central point. Last 6th point at the angle is chosen by the gradient of the previous calculated costs (FIG. 7).

FIG. 7 shows examples of an adaptive integer search pattern and a half sample search pattern.

The output of the DMVR process is the refined motion vector pair corresponding to the minimal cost.

If after one iteration the minimum cost is achieved at the central point of the search space, i.e. the motion vectors are not changed, and the refinement process is terminated. Otherwise, the best cost further is regarded as center, and the process continues, while the minimal cost does not correspond to the central point and the search range is not exceeded.

Half sample precision search is applied only if application of half-pel search does not exceed the search range. In this case only 4 MRSAD calculations are performed, corresponding to plus shape points around the central one, which is chosen as the best during the integer precision search. At the end the refined motion vector pair is output that correspond to the minimal cost point.

Some simplifications and improvements are further proposed in JVET-L0163.

### Reference Sampling Padding

Reference sample padding is applied in order to extend the reference sample block that is pointed by the initial motion vector. If the size of the coding block are given by “w” and “h”, then it is assumed that a block of size w+7 and h+7 is retrieved from the reference picture buffer. The retrieved buffer is then extended by 2 samples in each direction by repetitive sample padding using the nearest sample. Afterwards the extended reference sample block is used to generate the final prediction once the refined motion vector is obtained (which can deviate from the initial motion vector 2 samples in each direction).

It is noted that this modification eliminates the external memory access requirement of DMVR completely without any coding loss.

Bilinear Interpolation Instead of 8-tap DCTIF

According to the proposal bilinear interpolation is applied during the DMVR search process, which means that the predictions used in MRSAD computation are generated using bilinear interpolation. Once the final refined motion vectors are obtained regular 8-tap Discrete Cosine Transform-based Interpolation Filter (DCTIF) interpolation filter is applied to generate final predictions.

### Disabling of DMVR for Small Blocks

DMVR is disabled for blocks 4×4, 4×8 and 8×4.

Early Termination Based on MV Difference between Merge Candidates

An additional condition is imposed on DMVR to confine the MV refinement process. With it, DMVR is conditionally disabled when the below condition is satisfied.

The MV difference between the selected merge candidate and any of the previous ones in the same merge list is less than a pre-defined threshold (that is, ¼-, ½- and 1-pixel-wide intervals for CUs with less than 64 pixels, less than 256 pixels and at least 256 pixels, respectively).

### Early Termination Based on SAD Cost at the Center Search Coordinate

The sum of absolute difference (SAD) between the two prediction signals (L0 and L1 prediction) using the initial motion vectors of the current CU is calculated. If the SAD is no larger than a predefined threshold, i.e., 2^{(BDepth-9)} per sample, the DMVR is skipped; otherwise, the DMVR is still applied to refine the two motion vectors of the current block.

### DMVR Application Condition

The DMVR application condition is (POC−POC1)×(POC−POC2) <0 as it is implemented in BMS2.1 is replaced by the new condition (POC−POC1)==(POC2−POC). This means that DMVR is applied only if reference pictures are in opposite time directions and are equidistant to current picture.

### MRSAD Computation Using Every Second Row

The MRSAD cost is computed only for odd numbered rows of a block, the even numbered samples rows are not considered. Accordingly, the number of operations for the MRSAD calculation is halved.

### 2.6 Related Method

In the patent application identified by Application No. PCT/CN2018/098691 (which is incorporated by reference herein), entitled “Motion Refinement for Visual Media Coding,” filed Aug. 4, 2018, a MV update method and a two-step inter prediction method are proposed. The derived MV between reference block 0 and reference block 1 in BIO are scaled and added to the original motion vector of list 0 and list 1. Meanwhile, the updated MV is used to perform motion compensation and a second inter prediction is generated as the final prediction. The temporal gradient is modified by removing the mean difference between reference block 0 and reference block 1.

### 2.7 DMVR in VVC Draft 4

The usage of DMVR in JVET-M1001_v7 (VVC working draft 4, version 7) is defined as follows:
When all of the following conditions are true, dmvrFlag is set equal to 1:
sps_dmvr_enabled_flag is equal to 1
Current block is not coded with triangular prediction mode, AMVR affine mode, sub-block mode (including merge affine mode, and ATMVP mode)
merge_flag[xCb][yCb] is equal to 1
both predFlagL0[0][0] and predFlagL1[0][0] are equal to 1
mmvd_flag[xCb][yCb] is equal to 0
DiffPicOrderCnt(currPic, RefPicList[0][refIdxL0]) is equal to DiffPicOrderCnt(RefPicList[1][refIdxL1], currPic)
cbHeight is greater than or equal to 8
cbHeight*cbWidth is greater than or equal to 64

### 3. Examples of Problems Solved by Embodiments

In BIO, difference between two reference blocks or sub-blocks are calculated in the early termination stage, meanwhile, the temporal gradient is also calculated. Because the temporal gradient is actually the difference (or right shifted difference) between two reference pixels, calculating both the difference and the temporal gradient is not meaningful.

In DMVR, the MRSAD calculation is used to decide the refine motion vector of one block.

In BIO, the SAD calculation is used to decide whether BIO should be enabled/disabled for one block or one sub-block using all samples of one block/one sub-block which increases the computation complexity.

The calculation method is different for spatial gradient and temporal gradient.

### 4. Examples of Embodiments

Denote SATD as sum of absolute transformed differences, MRSATD as mean removed sum of absolute transformed differences, and SSE as sum of squares error, and MRSSE as mean removed sum of squares error.

The detailed techniques below should be considered as examples to explain general concepts. These techniques should not be interpreted in a narrow way. Furthermore, these inventions can be combined in any manner.

In the following discussion, SatShift(x, n) is defined as

$$SatShift ( x , n ) = \{ \begin{matrix}( x + offsset 0 ) >> n if x \geq 0 \\ - ( ( - x + offset 1 ) >> n ) if x < 0\end{matrix}$$

Shift(x, n) is defined as Shift(x, n)=(x+offset0)>>n.

In one example, offset0 and/or offset1 are set to (1<<n)>>1 or (1<<(n−1)). In another example, offset0 and/or offset are set to 0.

In another example, offset0=offset1=((1<<n)>>1)−1 or ((1<<(n−1)))−1.

In gradient calculation of BDOF, difference between two neighboring (either spatial neighboring or temporal neighboring) or/and non-adjacent samples may be calculated, and right-shift may be performed during the gradient calculation. Suppose the two neighboring samples are neig0 and neig1, and the right shift value is shift1, and the gradient to be calculated is grad. Note that shift1 may be different for spatial gradient and temporal gradient.
1. It is proposed to align the method used in calculating spatial gradient and temporal gradient.
   a. In one example, gradient is calculated according to the shifted sample differences.
      i. Alternatively, gradient is calculated according to the modified sample (e.g., via shifting) differences.
   b. In one example, in gradient calculation, subtraction may be performed before right shift. E.g., grad=(neig0−neig1)>>shift1.
   c. In one example, in gradient calculation, subtraction may be performed after right shift. E.g., grad=(neig0>>shift1)−(neig1>>shift1).
   d. In one example, in gradient calculation, subtraction may be performed before right shift and an offset may be added before right shift. E.g., grad=(neig0−neig1+offset)>>shift1. The offset may be equal to 1<<(shift1−1) or 1<<shift1>>1.
   e. In one example, in gradient calculation, subtraction may be performed after right shift and an offset may be added before right shift. E.g., grad=((neig0+offset)>>shift1)−((neig1+offset)>>shift1). The offset may be equal to 1<<(shift1−1) or 1<<shift1>>1.
   f. In one example, the gradient may be calculated as SatShift(neig0−neig1, shift1).
      i. Alternatively, the gradient may be calculated as SatShift(neig0, shift1)−SatShift(neig1, shift1).
2. It is proposed to use other criteria to decide the enabling/disabling of BIO or/and DMVR in the early termination stage, such as SATD or MRSATD or SSE or MRSSE or mean value difference or gradient values.
   a. In one example, the block level and sub-block level enabling/disabling decisions may choose different rules, e.g., one with SAD and the other with SATD.
   b. In one example, for a block/sub-block, if the gradient values (horizontal and/or vertical) or the averaged gradient values or the range of gradient values satisfy a condition, (e.g., larger than a threshold or outside a given range), BIO and/or DMVR may be disabled.
   c. It is proposed that the criteria used to decide the enabling/disabling BIO/DMVR may be signaled from the encoder to the decoder in video parameter set (VPS)/sequence parameter set (SPS)/picture parameter set (PPS)/slice header/tile group header.
3. It is proposed to use other criteria to decide the refined motion vector of one block in DMVR process, such as SATD or MRSATD or SSE or MRSSE to replace MRSAD.
   a. In one example, the refined motion vector of one sub-block in DMVR process, such as SATD or MRSATD or SSE or MRSSE to replace MRSAD.
   b. In one example, if SATD (or MRSATD) is applied, the whole block is split into M×N sub-blocks and SATD (or MRSATD) is calculated for each sub-block. The SATDs (or MRSATDs) for all or some of the sub-blocks are summed up to get the SATD (or MRSATD) value for the whole block.
4. BIO or/and DMVR may be disabled when mean value difference of two reference blocks of one block is larger than a threshold (T1).
   a. BIO may be disabled when mean value difference of two reference sub-blocks of one sub-block is larger than a threshold (T2).
   b. The thresholds T1 and/or T2 may be pre-defined.
   c. The thresholds T1 and/or T2 may be dependent on the block dimension.
5. It is proposed that in the early termination stage of BIO, before calculating the difference (e.g., SAD/SATD/SSE, etc.) between the two reference blocks/sub-blocks, the reference blocks or/and sub-blocks may be first modified.
   a. In one example, mean of the reference block or/and sub-block may be calculated and then subtracted by the reference block or/and sub-block.
   b. In one example, methods disclosed in App. No. PCT/CN2018/096384, (which is incorporated by reference herein), entitled “Motion Prediction Based on Updated Motion Vectors,” filed on Jul. 20, 2018, may be used to calculate the mean value of the reference block or/and sub-block, i.e., mean value is calculated for some representative positions.
6. It is proposed that in the early termination stage of BIO or/and DMVR, the difference (e.g., SAD/SATD/SSE/MRSAD/MRSATD/MRSSE, etc.) between the two reference blocks or/and sub-blocks may be calculated only for some representative positions.
   a. In one example, only difference of even rows is calculated for the block or/and sub-block.
   b. In one example, only difference of four corner samples of one block/sub-block is calculated for the block or/and sub-block.
   c. In one example, the methods disclosed in U.S. Provisional Application No. 62/693,412, (which is incorporated by reference herein) entitled “Decoder Side Motion Vector Derivation in Video Coding,” filed Jul. 2, 2018, may be used to select the representative positions.
   d. In one example, the difference (e.g., SAD/SATD/SSE/MRSAD/MRSATD/MRSSE, etc.) between the two reference blocks may be calculated only for some representative sub-blocks.
   e. In one example, the difference (e.g., SAD/SATD/SSE/MRSAD/MRSATD/MRSSE, etc.) calculated for representative positions or sub-blocks are summed up to get the difference for the whole block/sub-block.
7. It is proposed that temporal gradient (temporal gradient at position (x,y) is defined as G(x,y)=P0(x,y)−P1(x,y), where P0(x,y) and P1(x,y) represent the prediction at (x,y) from two different reference pictures) or modified temporal gradient is used as the difference (instead of SAD) in the early termination stage of BIO, and the threshold used in early termination may be adjusted accordingly.
   a. In one example, absolute sum of the temporal gradients is calculated and used as the difference of the two reference blocks or/and sub-blocks.
   b. In one example, absolute sum of the temporal gradients is calculated only on some representative positions for the block or/and sub-block.
   c. In one example, the methods disclosed in U.S. Provisional Application No. 62/693,412, (which is incorporated by reference herein) entitled “Decoder Side Motion Vector Derivation in Video Coding,” filed Jul. 2, 2018, may be used to select the representative positions.
8. It is proposed that the temporal gradient modification process may be performed adaptively for different blocks/sub-blocks.
   a. In one example, the temporal gradient is modified only when the absolute mean difference (or SAD/SATD/SSE, etc.) between the two reference blocks is greater than a threshold T, for example, T=4.
   b. In one example, the temporal gradient is modified only when the absolute mean difference (or SAD/SATD/SSE, etc.) between the two reference blocks is less than a threshold T, for example, T =20.
   c. In one example, the temporal gradient is modified only when the absolute mean difference (or SAD/SATD/SSE, etc.) between the two reference blocks is in the range of [T1, T2], for example, T1=4, T2=20.
   d. In one example, if the absolute mean difference (or SAD/SATD/SSE, etc.) between the two reference blocks is greater than a threshold T (for example, T=40), BIO is disabled.
   e. In one example, these thresholds may be predefined implicitly.
   f. In one example, these thresholds may be signaled in SPS/PPS/picture/slice/tile level.
   g. In one example, these thresholds may be different for different CU, largest coding unit (LCU), slice, tile or picture.
      i. In one example, these thresholds may be designed based on decoded/encoded pixel values.
      ii. In one example, these thresholds may be designed differently for different reference pictures.
   h. In one example, the temporal gradient is modified only when (absolute) mean of the two (or anyone of the two) reference blocks is greater than a threshold T, for example, T=40.
   i. In one example, the temporal gradient is modified only when (absolute) mean of the two (or anyone of the two) reference blocks is smaller than a threshold T, for example, T=100.
   j. In one example, the temporal gradient is modified only when (absolute) mean of the two (or anyone of the two) reference blocks are in the range of [T1, T2], for example, T1=40, T2=100.
   k. In one example, the temporal gradient is modified only when (absolute) mean of the two (or anyone of the two) reference blocks is greater/less than the absolute mean difference (or SAD/SATD etc.) multiplied by T, in one example, T=4.5.
   l. In one example, the temporal gradient is modified only when (absolute) mean of the two (or anyone of the two) reference blocks is in the range of the absolute mean difference (or SAD/SATD etc.) multiplied by [T1, T2], in one example, T1=4.5, T2=7.
9. It is proposed that in hybrid intra and inter prediction mode, the two inter reference blocks may be modified when calculating the spatial gradients in BIO, or they may be modified before performing the entire BIO procedure.
   a. In one example, the intra prediction block and the inter prediction block in each prediction direction are weighted averaged (using same weighting method as in hybrid inter and inter prediction) to generate two new prediction blocks, denoted as wAvgBlkL0 and wAvgBlkL1, which are used to derive the spatial gradients in BIO.
   b. In one example, wAvgBlkL0 and wAvgBlkL1 are used to generate the prediction block of the current block, denoted as predBlk. Then, wAvgBlkL0, wAvgBlkL1 and predBlk are further used for the BIO procedure, and the refined prediction block generated in BIO is used as the final prediction block.
10. It is proposed that a DMVR or/and BIO flag may be signaled at block level to indicate whether DMVR or/and BIO is enabled for the block.
   a. In one example, such flag may be signaled only for AMVP mode, and in merge mode, such flag may be inherited from spatial or/and temporal neighboring blocks.
   b. In one example, whether BIO or/and DMVR is enabled or not may be decided jointly by the signaled flag and the on-the-fly decision (for example, the decision based on SAD in the early termination stage). The signaled flag may indicate whether the on-the-fly decision is correct or not.
   c. Such flag is not signaled for uni-predicted blocks.
   d. Such flag may be not signaled for bi-predicted blocks whose two reference pictures are both preceding pictures or following pictures in display order.
   e. Such flag may be not signaled for bi-predicted blocks if POC_diff(curPic, ref0) is not equal to POC_diff(ref1, curPic), wherein POC_diff ( ) calculates the POC difference between two pictures, and ref0 and ref1 are the reference pictures of current picture.
   f. Such a flag is not signaled for intra coded blocks. Alternatively, furthermore, such a flag is not signaled for blocks coded with the hybrid intra and inter prediction mode. Alternatively, such a flag is not signaled for current picture referencing block, i.e. the reference picture is the current picture.
   g. Whether to signal the flag may depend on the block dimension. For example, if the block size is smaller than a threshold, such a flag is not signaled. Alternatively, if the block width and/or height is equal to or larger than a threshold, such a flag is not signaled.
   h. Whether to signal the flag may depend on the motion vector precision. For example, if the motion vector is in integer precision, such a flag is not signaled.
   i. If such a flag is not signaled, it may be derived to be true or false implicitly.
   j. A flag may be signaled at slice header/tile header/PPS/SPS/VPS to indicate whether this method is enabled or not.
   k. Such signaling method may depend on the temporal layer of the picture, for example, it may be disabled for picture with high temporal layer.
   l. Such signaling method may depend on the QP of the picture, for example, it may be disabled for picture with high QP.
11. Instead of checking both block height and block size, it is proposed to decide whether to enable or disable DMVR according to the block height only.
   a. In one example, DMVR may be enabled when the block height is greater than T1 (e.g., T1=4).
   b. In one example, DMVR may be enabled when the block height is equal to or greater than T1 (e.g., T1=8).
12. The above methods which are applied to DMVR/BIO may be only applicable to other decoder-side motion vector derivation (DMVD) methods, such as prediction refinement based on optical flow for the affine mode.
   a. In one example, the condition check for usage determination of DMVR and BIO may be aligned, such as whether block height satisfies same threshold.
      i. In one example, DMVR and BIO may be enabled when the block height is equal to or greater than T1 (e.g., T1=8).
      ii. In one example, DMVR and BIO may be enabled when the block height is greater than T1 (e.g., T1=4).

### 5. Embodiment

### 5.1 Embodiment #1

The usage of DMVR in JVET-M1001_v7 (VVC working draft 4, version 7) is modified as follows:
When all of the following conditions are true, dmvrFlag is set equal to 1:
   sps_dmvr_enabled_flag is equal to 1
   Current block is not coded with triangular prediction mode, AMVR affine mode, sub-block mode (including merge affine mode, and ATMVP mode)
   merge_flag[xCb][yCb] is equal to 1
   both predFlagL0[0][0] and predFlagL1[0][0] are equal to 1
   mmvd_flag[xCb][yCb] is equal to 0
   DiffPicOrderCnt (currPic, RefPicList[0][refIdxL0]) is equal to DiffPicOrderCnt(RefPicList[1][refIdxL1], currPic)
   cbHeight is greater than or equal to 8
   [[[cbHeight*cbWidth is greater than or equal to 64]]]

That means, “cbHeight*cbWidth is greater than or equal to 64” is deleted.

### 5.2 Embodiment #2

The newly added parts are highlighted in double brackets {{}}, and the deleted part are highlighted in triple brackets [[[]]].

i. One Example

### 8.5.7.4 Bidirectional Optical Flow Prediction Process

Inputs to this process are:
two variables nCbW and nCbH specifying the width and the height of the current coding block,
two (nCbW+2)×(nCbH+2) luma prediction sample arrays predSamplesL0 and predSamplesL1,
the prediction list utilization flags predFlagL0 and predFlagL1,
the reference indices refIdxL0 and refIdxL1,
the bidirectional optical flow utilization flags bdofUtilizationFlag[xIdx][yIdx] with xIdx=0 . . . (nCbW>>2)−1, yIdx=0 . . . (nCbH>>2)−1.

Output of this process is the (nCbW)×(nCbH) array pbSamples of luma prediction sample values.

Variables bitDepth, shift1, shift2, shift3, shift4, offset4, and mvRefineThres are derived as follows:
The variable bitDepth is set equal to BitDepthy.
The variable shift1 is set to equal to Max(2, 14−bitDepth).
The variable shift2 is set to equal to Max(8, bitDepth−4).
The variable shift3 is set to equal to Max(5, bitDepth−7).
The variable shift4 is set equal to Max(3, 15−bitDepth) and the variable offset4 is set equal to 1<<(shift4−1).
The variable mvRefineThres is set equal to Max(2, 1<<(13-bitDepth)).

For xIdx=0 . . . (nCbW>>2)−1 and yIdx=0 . . . (nCbH>>2)−1, the following applies:
The variable xSb is set equal to (xIdx<<2)+1 and ySb is set equal to (yIdx<<2)+1.
If bdofUtilizationFlag[xSbIdx][yIdx] is equal to FALSE, for x=xSb−1 . . . xSb+2, y=ySb−1 . . . ySb+2, the prediction sample values of the current subblock are derived as follows:

$$pbSamples [ x ] [ y ] = Clip 3 ( 0 , ( {2}^{b i t D e p t h} ) - 1 , ( p r e d S a m p l esL 0 [ x + 1 ] [ y + 1 ] + offset 2 + predSamplesL 1 [ x + 1 ] [ y + 1 ] ) >> shift 2 )$$

Otherwise (bdofUtilizationFlag[xSbIdx][yIdx] is equal to TRUE), the prediction sample values of the current subblock are derived as follows:
   For x=xSb−1 . . . xSb+4, y=ySb−1 . . . ySb+4, the following ordered steps apply:
      4. The locations (hₓ, V_{y}) for each of the corresponding sample locations (x, y) inside the prediction sample arrays are derived as follows:

$${h}_{x} = C lip 3 ( 1 , nCbW , x ) \qquad ( 8 - 853 )$$

$${v}_{y} = C lip 3 ( 1 , nCbH , y ) \qquad ( 8 - 854 )$$

5. The variables gradientHL0[x][y], gradient VL0[x][y], gradientHL1 [x][y] and gradientVL1 [x][y] are derived as follows:

$$gradientHL 0 [ x ] [ y ] = ( predSamplesL 0 [ {h}_{x} + 1 ] [ {v}_{y} ] - predSampleL 0 [ {h}_{x} - 1 ] [ {v}_{y} ] ) >> shift 1 \qquad ( 8 - 855 )$$

$$gradientVL 0 [ x ] [ y ] = ( predSamplesL 0 [ {h}_{x} ] [ {v}_{y} + 1 ] - predSampleL 0 [ {h}_{x} ] [ {v}_{y} - 1 ] ) >> shift 1 \qquad ( 8 - 856 )$$

$$gradientHL 1 [ x ] [ y ] = ( predSamplesL 1 [ {h}_{x} + 1 ] [ {v}_{y} ] - predSampleL 1 [ {h}_{x} - 1 ] [ {v}_{y} ] ) >> shift 1 \qquad ( 8 - 857 )$$

$$gradientVL 1 [ x ] [ y ] = ( predSamplesL 1 [ {h}_{x} ] [ {v}_{y} + 1 ] - predSampleL 1 [ {h}_{x} ] [ {v}_{y} - 1 ] ) >> shift 1 \qquad ( 8 - 858 )$$

6. The variables temp[x][y], tempH [x][y] and tempV [x][y] are derived as follows:

$$[ [ [ diff [ x ] [ y ] = ( predSamplesL 0 [ {h}_{x} ] [ {v}_{y} ] >> shift 2 ) - ( predSamplesL 1 [ {h}_{x} ] [ {v}_{y} ] >> shift 2 ) ] ] ] \qquad ( 8 - 859 )$$

$$\{ \{ diff [ x ] [ y ] = ( predSamplesL 0 [ {h}_{x} ] [ {v}_{y} ] - predSamplesL 1 [ {h}_{x} ] [ {v}_{y} ] ) >> shift 2 ) \} \} \qquad ( 8 - 859 )$$

$$tempH [ x ] [ y ] = ( gradientHL 0 [ x ] [ y ] + gradientHL 1 [ x ] [ y ] ) >> shift 3 \qquad ( 8 - 860 )$$

$$tempV [ x ] [ y ] = ( gradientVL 0 [ x ] [ y ] + gradientVL 1 [ x ] [ y ] ) >> shift 3 \qquad ( 8 - 861 )$$

The variables sGx2, sGy2, sGxGy, sGxdI and sGydI are derived as follows:

$$sGx 2 = {Σ}_{i} {Σ}_{j} ( t empH [ xS b + i ] [ y S b + j ] * temp H [ x S b + i ] [ y S b + j ] ) \qquad ( 8 - 862 )$$

$$with i , j = - 1 … 4$$

$$sGy 2 = {Σ}_{i} {Σ}_{j} ( tempV [ xSb + i ] [ y S b + j ] * tempV [ xSb + i ] [ y S b + j ] ) \qquad ( 8 - 863 )$$

$$with i , j = - 1 … 4$$

$$sGyGy = {Σ}_{i} {Σ}_{j} ( tempH [ xSb + i ] [ y S b + j ] * tempV [ xSb + i ] [ y S b + j ] ) \qquad ( 8 - 864 )$$

$$with i , j = - 1 … 4$$

$$sGxdI = {Σ}_{i} {Σ}_{j} ( - tempH [ xS b + i ] [ y S b + j ] * dif f [ x S b + i ] [ y S b + j ] ) \qquad ( 8 - 865 )$$

$$with i , j = - 1 … 4$$

$$sGydI = {Σ}_{i} {Σ}_{j} ( - tempV [ xSb + i ] [ y S b + j ] * dif f [ x S b + i ] [ y S b + j ] ) \qquad ( 8 - 866 )$$

$$with i , j = - 1 … 4$$

The horizontal and vertical motion offset of the current subblock are derived as:

$${v}_{x} = sGx 2 > 0 ? Clip 3 ( - mvRefineThres , mvRefineThres , - ( sGxdI << 3 ) >> Floor ( Log 2 ( sGx 2 ) ) ) : 0 \qquad ( 8 - 867 )$$

$${v}_{y} = sGy 2 > 0 ? Clip 3 ( - mvRefineThres , mvRefineThres , ( ( sGydI << 3 ) - ( ( {v}_{x} * {sGxGy}_{m} ) << 12 + {v}_{x} * sGxGys ) >> 1 ) >> Floor ( Log 2 ( sGx 2 ) ) ) : 0 \qquad ( 8 - 868 )$$

For x=xSb−1 . . . xSb+2, y=ySb−1 . . . ySb+2, the prediction sample values of the current sub-block are derived as follows:

$$bdofOffset = Round ( ( {v}_{x} * ( gradientHL 1 [ x + 1 ] [ y + 1 ] - gradientHL 0 [ x + 1 ] [ y + 1 ] ) ) >> 1 ) + Round ( ( {v}_{y} * gradientVL 1 [ x + 1 ] [ y + 1 ] - gradientVL 0 [ x + 1 ] [ y + 1 ] ) ) >> 1 ) \qquad ( 8 - 869 )$$

$$pbSamples [ x ] [ y ] = Clip 3 ( 0 , ( {2}^{bitDepth} ) - 1 , ( predSamplesL 0 [ x + 1 ] [ y + 1 ] + offset 4 + predSamplesL 1 [ x + 1 ] [ y + 1 ] + bdofOffset ) >> shift 4 ) \qquad ( 8 - 870 )$$

ii. One Example

### 8.5.7.4 Bidirectional Optical Flow Prediction Process

Inputs to this process are:
two variables nCbW and nCbH specifying the width and the height of the current coding block,
two (nCbW+2)×(nCbH+2) luma prediction sample arrays predSamplesL0 and predSamplesL1,
the prediction list utilization flags predFlagL0 and predFlagL1,
the reference indices refIdxL0 and refIdxL1,
the bidirectional optical flow utilization flags bdofUtilizationFlag[xIdx][yIdx] with xIdx=0 . . . (nCbW>>2)−1, yIdx=0 . . . (nCbH>>2)−1.

Output of this process is the (nCbW)×(nCbH) array pbSamples of luma prediction sample values.

Variables bitDepth, shift1, shift2, shift3, shift4, offset4, and mvRefineThres are derived as follows:
The variable bitDepth is set equal to BitDepth_{Y}.
The variable shift1 is set to equal to Max(2, 14−bitDepth).
The variable shift2 is set to equal to Max(8, bitDepth−4).
The variable shift3 is set to equal to Max(5, bitDepth−7).
The variable shift4 is set equal to Max(3, 15−bitDepth) and the variable offset4 is set equal to 1<<(shift4−1).
The variable mvRefineThres is set equal to Max(2, 1<<(13−bitDepth)).

For xIdx=0 . . . (nCbW>>2)−1 and yIdx=0 . . . (nCbH>>2)−1, the following applies:
The variable xSb is set equal to (xIdx<<2)+1 and ySb is set equal to (yIdx<<2)+1.
If bdofUtilizationFlag[xSbIdx][yIdx] is equal to FALSE, for x=xSb−1 . . . xSb+2, y=ySb−1 . . . ySb+2, the prediction sample values of the current subblock are derived as follows:

$$pbSamples [ x ] [ y ] = Clip 3 ( 0 , ( {2}^{bitDepth} ) - 1 , ( predSamplesL 0 [ x + 1 ] [ y + 1 ] + offset 2 + predSamplesL 1 [ x + 1 ] [ y + 1 ] ) >> shift 2 ) \qquad ( 8 - 852 )$$

Otherwise (bdofUtilizationFlag[xSbIdx][yIdx] is equal to TRUE), the prediction sample values of the current subblock are derived as follows:
   For x=xSb−1 . . . xSb+4, y=ySb−1 . . . ySb+4, the following ordered steps apply:
      7. The locations (hₓ, V_{y}) for each of the corresponding sample locations (x, y) inside the prediction sample arrays are derived as follows:

$${h}_{x} = Clip 3 ( 1 , nCbW , x ) \qquad ( 8 - 853 )$$

$${v}_{y} = Clip 3 ( 1 , nCbH , y ) \qquad ( 8 - 854 )$$

8. The variables gradientHL0[x][y], gradient VL0[x][y], gradientHL1 [x][y] and gradientVL1 [x][y] are derived as follows:

$$[ [ [ gradientHL 0 [ x ] [ y ] = ( predSamplesL 0 [ {h}_{x} + 1 ] [ {v}_{y} ] - predSampleL 0 [ {h}_{x} - 1 ] [ {v}_{y} ] ) >> shift 1 ] ] ] \qquad ( 8 - 855 )$$

$$[ [ [ gradientVL 0 [ x ] [ y ] = ( predSamplesL 0 [ {h}_{x} ] [ {v}_{y} + 1 ] - predSampleL 0 [ {h}_{x} ] [ {v}_{y} - 1 ] ) >> shift 1 ] ] ] \qquad ( 8 - 856 )$$

$$[ [ [ gradientHL 1 [ x ] [ y ] = ( predSamplesL 1 [ {h}_{x} + 1 ] [ {v}_{y} ] - predSampleL 1 [ {h}_{x} - 1 ] [ {v}_{y} ] ) >> shift 1 ] ] ] \qquad ( 8 - 857 )$$

$$[ [ [ gradientVL 1 [ x ] [ y ] = ( predSamplesL 1 [ {h}_{x} ] [ {v}_{y} + 1 ] - predSampleL 1 [ {h}_{x} ] [ {v}_{y} - 1 ] ) >> shift 1 ] ] ] \qquad ( 8 - 858 )$$

$$\{ \{ gradientHL 0 [ x ] [ y ] = ( predSamplesL 0 [ {h}_{x} + 1 ] [ {v}_{y} ] >> shift 1 ) - predSampleL 0 [ {h}_{x} - 1 ] [ {v}_{y} ] ) >> shift 1 ) \} \} \qquad ( 8 - 855 )$$

$$\{ \{ gradientVL 0 [ x ] [ y ] = ( predSamplesL 0 [ {h}_{x} ] [ {v}_{y} + 1 ] >> shift 1 ) - predSampleL 0 [ {h}_{x} ] [ {v}_{y} - 1 ] ) >> shift 1 ) \} \} \qquad ( 8 - 856 )$$

$$\{ \{ gradientHL 1 [ x ] [ y ] = ( predSamplesL 1 [ {h}_{x} + 1 ] [ {v}_{y} ] >> shift 1 ) - predSampleL 1 [ {h}_{x} - 1 ] [ {v}_{y} ] ) >> shift 1 ) \} \} \qquad ( 8 - 857 )$$

$$\{ \{ gradientVL 1 [ x ] [ y ] = ( predSamplesL 1 [ {h}_{x} ] [ {v}_{y} + 1 ] >> shift 1 ) - predSampleL 1 [ {h}_{x} ] [ {v}_{y} - 1 ] ) >> shift 1 ) \} \} \qquad ( 8 - 858 )$$

9. The variables temp[x][y], tempH[x][y] and tempV[x][y] are derived as follows:

$$diff [ x ] [ y ] = ( predSamplesL 0 [ {h}_{x} ] [ {v}_{y} ] >> shift 2 ) - ( predSampleL 1 [ {h}_{x} ] [ {v}_{y} ] >> shift 2 ) \qquad ( 8 - 859 )$$

$$tempH [ x ] [ y ] = ( gradientHL 0 [ x ] [ y ] + gradientHL 1 [ x ] [ y ] ) >> shift 3 \qquad ( 8 - 860 )$$

$$tempV [ x ] [ y ] = ( gradientVL 0 [ x ] [ y ] + gradientVL 1 [ x ] [ y ] ) >> shift 3 \qquad ( 8 - 861 )$$

The variables sGx2, sGy2, sGxGy, sGxdI and sGydI are derived as follows:

$$sGx 2 = {\sum }_{i} {\sum }_{j} ( tempH [ xSb + i ] [ ySb + j ] * tempH [ xSb + i ] [ ySb + j ] ) with i , j = - 1 … 4 \qquad ( 8 - 862 )$$

$$sGy 2 = {\sum }_{i} {\sum }_{j} ( tempV [ xSb + i ] [ ySb + j ] * tempV [ xSb + i ] [ ySb + j ] ) with i , j = - 1 … 4 \qquad ( 8 - 863 )$$

$$sGxGy = {\sum }_{i} {\sum }_{j} ( tempH [ xSb + i ] [ ySb + j ] * tempV [ xSb + i ] [ ySb + j ] ) with i , j = - 1 … 4 \qquad ( 8 - 864 )$$

$$sGxdI = {\sum }_{i} {\sum }_{j} ( - tempH [ xSb + i ] [ ySb + j ] * diff [ xSb + i ] [ ySb + j ] ) with i , j = - 1 … 4 \qquad ( 8 - 865 )$$

$$sGydI = {\sum }_{i} {\sum }_{j} ( - tempV [ xSb + i ] [ ySb + j ] * diff [ xSb + i ] [ ySb + j ] ) with i , j = - 1 … 4 \qquad ( 8 - 866 )$$

The horizontal and vertical motion offset of the current subblock are derived as:

$${v}_{x} = sGx 2 > 0 ? Clip 3 ( - mvRefineThres , mvRefineThres , - ( sGxdI << 3 ) >> Floor ( Log 2 ( sGx 2 ) ) ) : 0 \qquad ( 8 - 867 )$$

$${v}_{y} = sGy 2 > 0 ? Clip 3 ( - mvRefineThres , mvRefineThres , ( sGxdI << 3 ) - ( ( {v}_{x} * {sGxGy}_{m} ) << 12 + {v}_{x} * {sGxGy}_{s} ) >> 1 ) >> Floor ( Log 2 ( sGx 2 ) ) ) : 0 \qquad ( 8 - 868 )$$

For x=xSb−1 . . . xSb+2, y=ySb−1 . . . ySb+2, the prediction sample values of the current sub-block are derived as follows:

$$bdofOffset = Round ( ( {v}_{x} * ( gradientHL 1 [ x + 1 ] [ y + 1 ] - gradientHL 0 [ x + 1 ] [ y + 1 ] ) ) >> 1 ) + Round ( ( {v}_{y} * gradientVL 1 [ x + 1 ] [ y + 1 ] - gradientVL 0 [ x + 1 ] [ y + 1 ] ) ) >> 1 ) \qquad ( 8 - 869 )$$

$$pbSamples [ x ] [ y ] = Clip 3 ( 0 , ( {2}^{bitDepth} ) - 1 , ( predSamplesL 0 [ x + 1 ] [ y + 1 ] + offset 4 + predSamplesL 1 [ x + 1 ] [ y + 1 ] + bdofOffset ) >> shift 4 ) \qquad ( 8 - 870 )$$

iii. One Example

### 8.5.7.4 Bidirectional Optical Flow Prediction Process

Inputs to this process are:
two variables nCbW and nCbH specifying the width and the height of the current coding block,
two (nCbW+2)×(nCbH+2) luma prediction sample arrays predSamplesL0 and predSamplesL1,
the prediction list utilization flags predFlagL0 and predFlagL1,
the reference indices refIdxL0 and refIdxL1,
the bidirectional optical flow utilization flags bdofUtilizationFlag[xIdx][yIdx] with xIdx=0 . . . (nCbW>>2)−1, yIdx=0 . . . (nCbH>>2)−1.

Output of this process is the (nCbW)×(nCbH) array pbSamples of luma prediction sample values.

Variables bitDepth, shift1, shift2, shift3, shift4, offset4, {{offset5, offset6}}, and mvRefineThres are derived as follows:
The variable bitDepth is set equal to BitDepthy.
The variable shift1 is set to equal to Max(2, 14−bitDepth).
The variable shift2 is set to equal to Max(8, bitDepth−4).
The variable shift3 is set to equal to Max(5, bitDepth−7).
The variable shift4 is set equal to Max(3, 15−bitDepth) and the variable offset4 is set equal to 1<<(shift4−1).
The variable mvRefineThres is set equal to Max(2, 1<<(13−bitDepth)).
{{The variable offset5 is set equal to (1<<(shift1−1)).}}

{{The variable offset6 is set equal to (1<<(shift2−1)).}}

For xIdx=0 . . . (nCbW>>2)−1 and yIdx=0 . . . (nCbH>>2)−1, the following applies:
The variable xSb is set equal to (xIdx<<2)+1 and ySb is set equal to (yIdx<<2)+1.
If bdofUtilizationFlag[xSbIdx][yIdx] is equal to FALSE, for x=xSb−1 . . . xSb+2, y=ySb−1 . . . ySb+2, the prediction sample values of the current subblock are derived as follows:

$$pbSamples [ x ] [ y ] = Clip 3 ( 0 , ( {2}^{bitDepth} ) - 1 , ( predSamplesL 0 [ x + 1 ] [ y + 1 ] + offset 2 + predSamplesL 1 [ x + 1 ] [ y + 1 ] ) >> shift 2 ) \qquad ( 8 - 852 )$$

Otherwise (bdofUtilizationFlag[xSbIdx][yIdx] is equal to TRUE), the prediction sample values of the current subblock are derived as follows:
For x=xSb-1 . . . xSb+4, y=ySb−1 . . . ySb+4, the following ordered steps apply:
   10. The locations (hₓ, V_{y}) for each of the corresponding sample locations (x, y) inside the prediction sample arrays are derived as follows:

$${h}_{x} = Clip 3 ( 1 , nCbW , x ) \qquad ( 8 - 853 )$$

$${v}_{y} = Clip 3 ( 1 , nCbH , y ) \qquad ( 8 - 854 )$$

11. The variables gradientHL0[x][y], gradient VL0[x][y], gradientHL1 [x][y] and gradientVL1 [x][y] are derived as follows:

$$gradientHL 0 [ x ] [ y ] = ( predSamplesL 0 [ {h}_{x} + 1 ] [ {v}_{y} ] - predSampleL 0 [ {h}_{x} - 1 ] [ {v}_{y} ] + offset 5 ) >> shift 1 \qquad ( 8 - 855 )$$

$$gradientVL 0 [ x ] [ y ] = ( predSamplesL 0 [ {h}_{x} ] [ {v}_{y} + 1 ] - predSampleL 0 [ {h}_{x} ] [ {v}_{y} - 1 ] + offset 5 ) >> shift 1 \qquad ( 8 - 856 )$$

$$gradientHL 1 [ x ] [ y ] = ( predSamplesL 1 [ {h}_{x} + 1 ] [ {v}_{y} ] - predSampleL 1 [ {h}_{x} - 1 ] [ {v}_{y} ] + offset 5 ) >> shift 1 \qquad ( 8 - 857 )$$

$$gradientVL 1 [ x ] [ y ] = ( predSamplesL 1 [ {h}_{x} ] [ {v}_{y} + 1 ] - predSampleL 1 [ {h}_{x} ] [ {v}_{y} - 1 ] + offset 5 ) >> shift 1 \qquad ( 8 - 858 )$$

12. The variables temp[x][y], tempH[x][y] and tempV[x][y] are derived as follows:

$$[ [ [ diff [ x ] [ y ] = ( predSamplesL 0 [ {h}_{x} ] [ {v}_{y} ] >> shift 2 ) - ( predSamplesL 1 [ {h}_{x} ] [ {v}_{y} ] >> shift 2 ) ] ] ] \qquad ( 8 - 859 )$$

$$\{ \{ diff [ x ] [ y ] = ( predSamplesL 0 [ {h}_{x} ] [ {v}_{y} ] - ( predSamplesL 1 [ {h}_{x} ] [ {v}_{y} ] + offset 6 ) >> shift 2 \} \} \qquad ( 8 - 859 )$$

$$tempH [ x ] [ y ] = ( gradientHL 0 [ x ] [ y ] + gradientHL 1 [ x ] [ y ] ) >> shift 3 \qquad ( 8 - 860 )$$

$$tempV [ x ] [ y ] = ( gradientVL 0 [ x ] [ y ] + gradientVL 1 [ x ] [ y ] ) >> shift 3 \qquad ( 8 - 861 )$$

The variables sGx2, sGy2, sGxGy, sGxdI and sGydI are derived as follows:

$$sGx 2 = {\sum }_{i} {\sum }_{j} ( tempH [ xSb + i ] [ ySb + j ] * tempH [ xSb + i ] [ ySb + j ] ) with i , j = - 1 … 4 \qquad ( 8 - 862 )$$

$$sGy 2 = {\sum }_{i} {\sum }_{j} ( tempV [ xSb + i ] [ ySb + j ] * tempV [ xSb + i ] [ ySb + j ] ) with i , j = - 1 … 4 \qquad ( 8 - 863 )$$

$$sGxGy = {\sum }_{i} {\sum }_{j} ( tempH [ xSb + i ] [ ySb + j ] * tempV [ xSb + i ] [ ySb + j ] ) with i , j = - 1 … 4 \qquad ( 8 - 864 )$$

$$sGxdI = {\sum }_{i} {\sum }_{j} ( - tempH [ xSb + i ] [ ySb + j ] * diff [ xSb + i ] [ ySb + j ] ) with i , j = - 1 … 4 \qquad ( 8 - 865 )$$

$$sGydI = {\sum }_{i} {\sum }_{j} ( - tempV [ xSb + i ] [ ySb + j ] * diff [ xSb + i ] [ ySb + j ] ) with i , j = - 1 … 4 \qquad ( 8 - 866 )$$

The horizontal and vertical motion offset of the current subblock are derived as:

$${v}_{x} = sGx 2 > 0 ? Clip 3 ( - mvRefineThres , mvRefineThres , - ( sGxdI << 3 ) >> Floor ( Log 2 ( sGx 2 ) ) ) : 0 \qquad ( 8 - 867 )$$

$${v}_{y} = sGy 2 > 0 ? Clip 3 ( - mvRefineThres , mvRefineThres , ( sGxdI << 3 ) - ( ( {v}_{x} * {sGxGy}_{m} ) << 12 + {v}_{x} * {sGxGy}_{s} ) >> 1 ) >> Floor ( Log 2 ( sGx 2 ) ) ) : 0 \qquad ( 8 - 868 )$$

For x=xSb−1 . . . xSb+2, y=ySb−1 . . . ySb+2, the prediction sample values of the current sub-block are derived as follows:

$$bdofOffset = Round ( ( {v}_{x} * ( gradientHL 1 [ x + 1 ] [ y + 1 ] - gradientHL 0 [ x + 1 ] [ y + 1 ] ) ) >> 1 ) + Round ( ( {v}_{y} * gradientVL 1 [ x + 1 ] [ y + 1 ] - gradientVL 0 [ x + 1 ] [ y + 1 ] ) ) >> 1 ) \qquad ( 8 - 869 )$$

$$pbSamples [ x ] [ y ] = Clip 3 ( 0 , ( {2}^{bitDepth} ) - 1 , ( predSamplesL 0 [ x + 1 ] [ y + 1 ] + offset 4 + predSamplesL 1 [ x + 1 ] [ y + 1 ] + bdofOffset ) >> shift 4 ) \qquad ( 8 - 870 )$$

FIG. 8 is a block diagram of a video processing apparatus 800. The apparatus 800 may be used to implement one or more of the methods described herein. The apparatus 800 may be embodied in a smartphone, tablet, computer, Internet of Things (IoT) receiver, and so on. The apparatus 800 may include one or more processors 802, one or more memories 804 and video processing hardware 806. The processor(s) 802 may be configured to implement one or more methods described in the present disclosure. The memory (memories) 804 may be used for storing data and code used for implementing the methods and techniques described herein. The video processing hardware 806 may be used to implement, in hardware circuitry, some techniques described in the present disclosure. The video processing hardware 806 may be partially or completely includes within the processor(s) 802 in the form of dedicated hardware, or graphical processor unit (GPU) or specialized signal processing blocks.

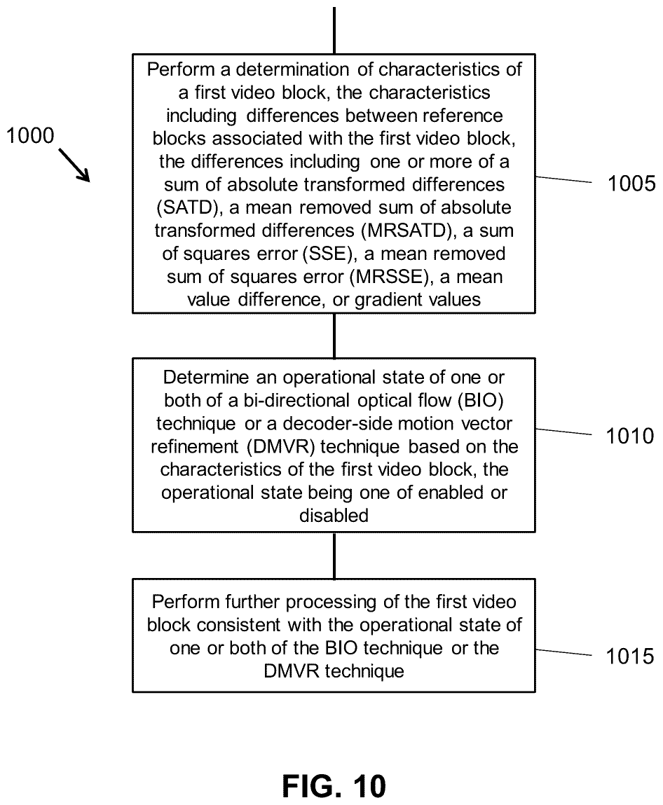

FIG. 10 is a flowchart for a method 1000 of processing a video. The method 1000 includes performing a determination (1005) of characteristics of a first video block, the characteristics including differences between reference blocks associated with the first video block, the differences including one or more of a sum of absolute transformed differences (SATD), a mean removed sum of absolute transformed differences (MRSATD), a sum of squares error (SSE), a mean removed sum of squares error (MRSSE), a mean value difference, or gradient values, determining (1010) an operational state of one or both of a bi-directional optical flow (BIO) technique or a decoder-side motion vector refinement (DMVR) technique based on the characteristics of the first video block, the operational state being one of enabled or disabled, and performing (1015) further processing of the first video block consistent with the operational state of one or both of the BIO technique or the DMVR technique.

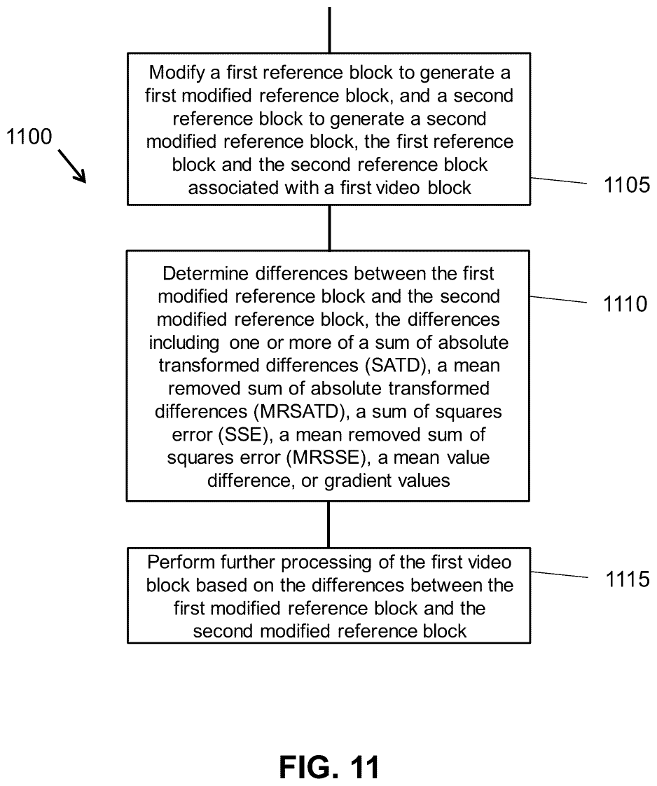

FIG. 11 is a flowchart for a method 1100 of processing a video. The method 1100 includes modifying (1105) a first reference block to generate a first modified reference block, and a second reference block to generate a second modified reference block, the first reference block and the second reference block associated with a first video block, performing (1110) differences between the first modified reference block and the second modified reference block, the differences including one or more of a sum of absolute transformed differences (SATD), a mean removed sum of absolute transformed differences (MRSATD), a sum of squares error (SSE), a mean removed sum of squares error (MRSSE), a mean value difference, or gradient values, and performing (1115) further processing of the first video block based on the differences between the first modified reference block and the second modified reference block.

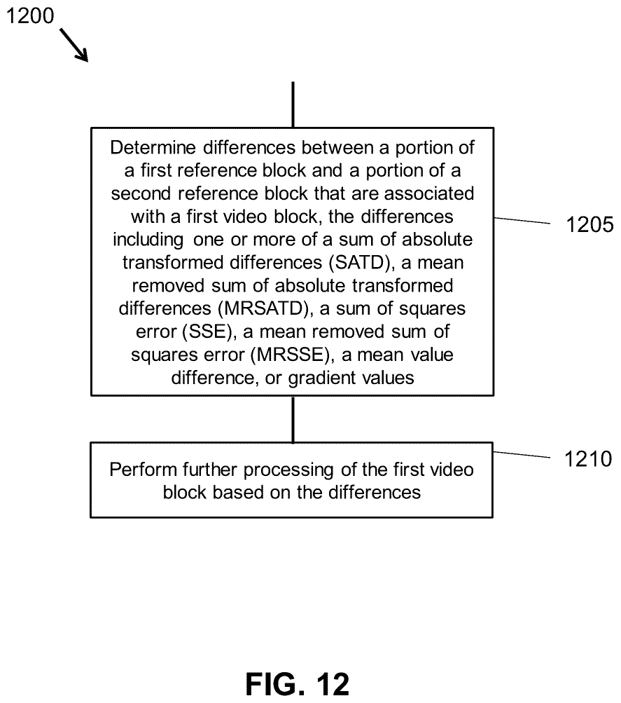

FIG. 12 is a flowchart for a method 1200 of processing a video. The method 1200 includes determining (1205) differences between a portion of a first reference block and a portion of a second reference block that are associated with a first video block, the differences including one or more of a sum of absolute transformed differences (SATD), a mean removed sum of absolute transformed differences (MRSATD), a sum of squares error (SSE), a mean removed sum of squares error (MRSSE), a mean value difference, or gradient values, and performing (1210) further processing of the first video block based on the differences.

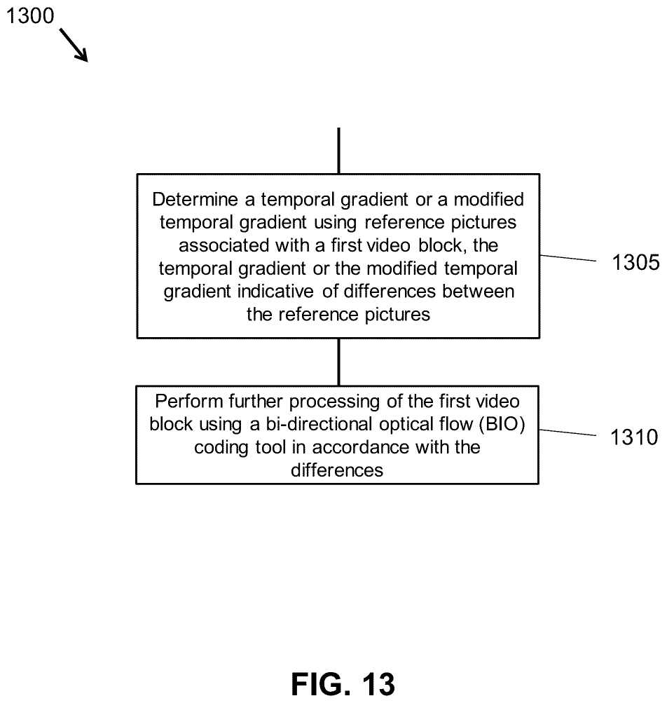

FIG. 13 is a flowchart for a method 1300 of processing a video. The method 1300 includes determining (1305) a temporal gradient or a modified temporal gradient using reference pictures associated with a first video block, the temporal gradient or the modified temporal gradient indicative of differences between the reference pictures, and performing (1310) further processing of the first video block using a bi-directional optical flow (BIO) coding tool in accordance with the differences.

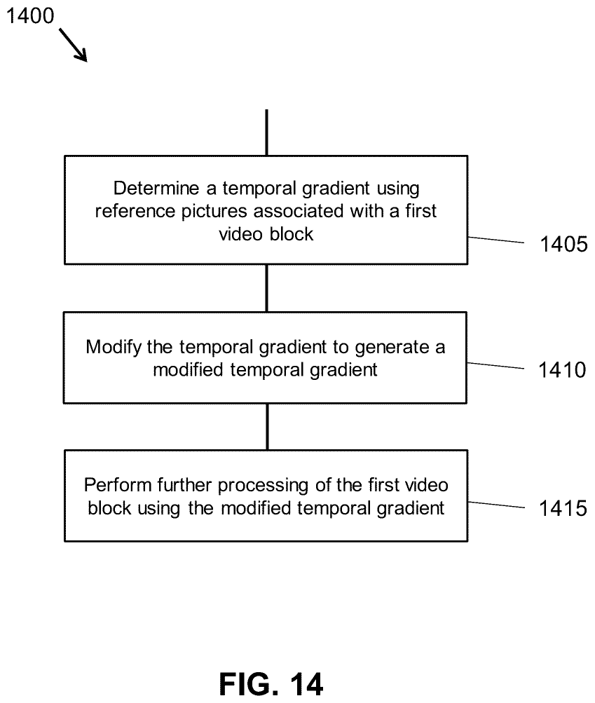

FIG. 14 is a flowchart for a method 1400 of processing a video. The method 1400 includes determining (1405) a temporal gradient using reference pictures associated with a first video block, modifying (1410) the temporal gradient to generate a modified temporal gradient, and performing (1415) further processing of the first video block using the modified temporal gradient.

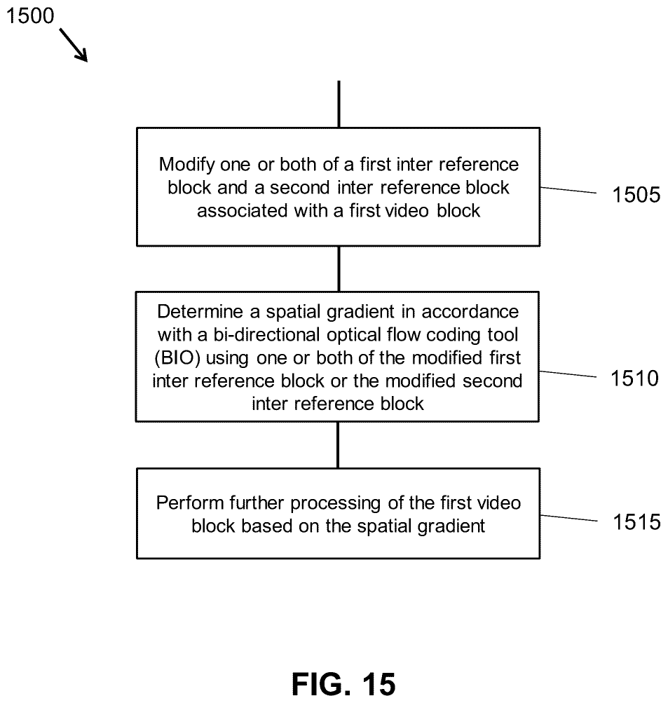

FIG. 15 is a flowchart for a method 1500 of processing a video. The method 1500 includes modifying (1505) one or both of a first inter reference block and a second inter reference block associated with a first video block, determining (1510) a spatial gradient in accordance with a bi-directional optical flow coding tool (BIO) using one or both of the modified first inter reference block or the modified second inter reference block, and performing (1515) further processing of the first video block based on the spatial gradient.

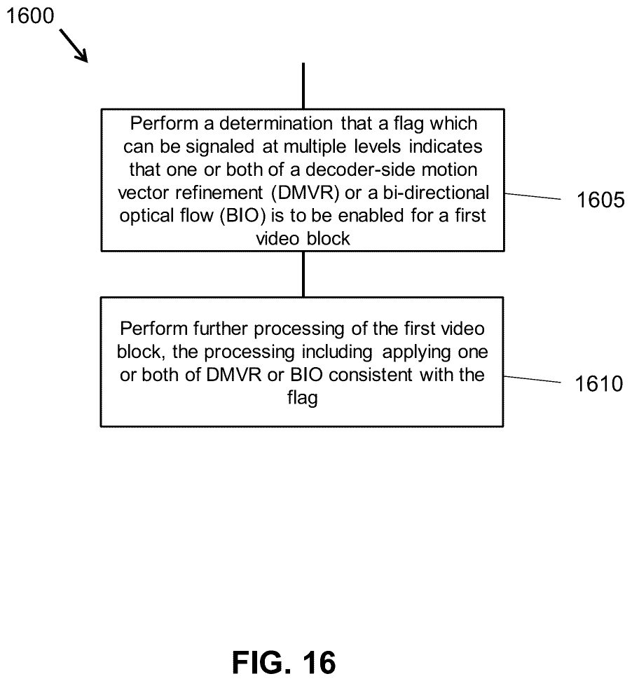

FIG. 16 is a flowchart for a method 1600 of processing a video. The method 1600 includes performing (1605) a determination that a flag which can be signaled at multiple levels indicates that one or both of a decoder-side motion vector refinement (DMVR) or a bi-directional optical flow (BIO) is to be enabled for a first video block, and performing (1610) further processing of the first video block, the processing including applying one or both of DMVR or BIO consistent with the flag.

With reference to methods 1000, 1100, 1200, 1300, 1400, 1500, and 1600, some examples of determining use of bi-directional optical flow (BIO) or decoder-side motion vector refinement (DMVR) are described in Section 4 of the present disclosure. For example, as described in Section 4, differences between reference blocks can be determined and the differences can be used to enable or disable BIO or DMVR.

With reference to methods 1000, 1100, 1200, 1300, 1400, 1500, and 1600, a video block may be encoded in the video bitstream in which bit efficiency may be achieved by using a bitstream generation rule related to motion information prediction.

The methods can include wherein the operational state of the BIO technique or the DMVR technique is different between a block-level and a sub-block level.

The methods can include determining that one or more of the gradient values, an average of the gradient values, or a range of the gradient values are within a threshold range, wherein determining the operational state is based on the determination the gradient values, the average of the gradient values, or the range of the gradient values are within the threshold range.

The methods can include wherein determining the operational state is further based on information signaled from an encoder to a decoder in a video parameter set (VPS), a sequence parameter set (SPS), a picture parameter set (PPS), a tile group header, a picture header, or a slice header.

The methods can include determining a refined motion vector of the first video block based on the SATD, MRSATD, SSE, or MRSSE, and wherein performing further processing is based on the refined motion vector.

The methods can include wherein determining the refined motion vector is based on SATD or MRSATD, the method further comprising: determining SATD or MRSATD for each sub-block of the first video block; and generating SATD or MRSATD for the first video block based on a summation of the SATD or MRSATD for each sub-block, wherein further processing of the first video block is based on the generated SATD or MRSATD.

The methods can include determining that a mean value difference of two reference blocks of the first video block is larger than a threshold value, and wherein one or both of BIO or DMVR is in a disabled operational state based on the mean value difference of the two reference blocks.

The methods can include determining that a mean value difference of two reference sub-blocks of a sub-block of the first video block is larger than a threshold value, and wherein one or both of BIO or DMVR is in a disabled operational state based on the mean value difference of the two reference sub-blocks.

The methods can include wherein the threshold value is pre-defined.

The methods can include determining dimensions of the first video block, and wherein the threshold value is based on the dimensions of the first video block.

The methods can include wherein modifying the first reference block and the second reference block includes subtracting a mean of the first reference block from the first reference block.

The methods can include wherein the portions of the first reference block and the second reference block include even rows.

The methods can include wherein the portions of the first reference block and the second reference block include corner samples.

The methods can include wherein the portions of the first reference block and the second reference block include representative sub-blocks.

The methods can include wherein differences between the representative sub-blocks are summed to

generate a difference for the first reference block or the second reference block.

The methods can include wherein the differences are related to an absolute sum of the temporal gradient.

The methods can include wherein modifying the temporal gradient is based on an absolute mean difference between the reference blocks being greater than a threshold value.

The methods can include wherein the threshold value is 4.

The methods can include wherein modifying the temporal gradient is based on an absolute mean difference between the reference blocks being less than a threshold value.

The methods can include wherein the threshold value is 20.

The methods can include wherein modifying the temporal gradient is based on an absolute mean difference between the reference blocks being within a threshold range.

The methods can include wherein BIO is in a disabled operational state based on the absolute mean difference being greater than a threshold value.

The methods can include wherein the threshold value or the threshold range is indicated in VPS, SPS, PPS, a picture, a slice, or a tile level.

The methods can include wherein the threshold value or the threshold range is different for different coding units (CUs), largest coding units (LCUs), slices, tiles, or pictures.

The methods can include wherein the threshold value or the threshold range is based on a decoded or encoded pixel value.

The methods can include wherein the threshold value or the threshold range is based on a reference picture.

The methods can include wherein determining the spatial gradient includes determining a weighted average of an intra prediction block and an inter prediction block in each prediction direction.

The methods can include wherein the flag is provided in advanced motion vector prediction (AMVP) mode, and in merge mode the flag is inherited from one or both of spatial neighboring blocks or temporal neighboring blocks.

The methods can include wherein the flag is not signaled for uni-predicted blocks.

The methods can include wherein the flag is not signaled for bi-predicted blocks with reference pictures that are preceding pictures or following pictures in display order.

The methods can include wherein the flag is not signaled for bi-predicted blocks.

The methods can include wherein the flag is not signaled for intra coded blocks.

The methods can include wherein the flag is not signaled for blocks coded with hybrid intra and inter prediction mode.

The methods can include wherein the flag is signaled based on a dimension of the first video block.

The methods can include wherein the flag is signaled in a VPS, a SPS, or a PPS.

The methods can include wherein the flag is based on a temporal layer of a picture associated with the first video block.

The methods can include wherein the flag is based on a quantization parameter (QP) of a picture associated with the first video block.

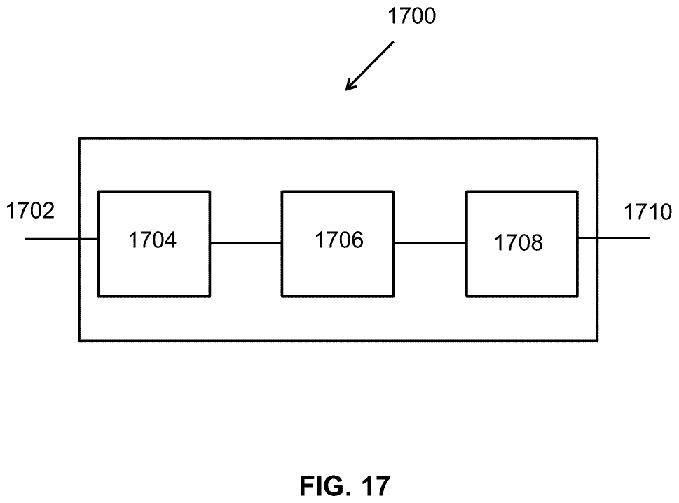

FIG. 17 is a block diagram showing an example video processing system 1700 in which various techniques disclosed herein may be implemented. Various implementations may include some or all of the components of the system 1700. The system 1700 may include input 1702 for receiving video content. The video content may be received in a raw or uncompressed format, e.g., 8 or 10 bit multi-component pixel values, or may be in a compressed or encoded format. The input 1702 may represent a network interface, a peripheral bus interface, or a storage interface. Examples of network interface include wired interfaces such as Ethernet, passive optical network (PON), etc. and wireless interfaces such as wireless fidelity (Wi-Fi) or cellular interfaces.

The system 1700 may include a coding component 1704 that may implement the various coding or encoding methods described in the present disclosure. The coding component 1704 may reduce the average bitrate of video from the input 1702 to the output of the coding component 1704 to produce a coded representation of the video. The coding techniques are therefore sometimes called video compression or video transcoding techniques. The output of the coding component 1704 may be either stored, or transmitted via a communication connected, as represented by the component 1706. The stored or communicated bitstream (or coded) representation of the video received at the input 1702 may be used by the component 1708 for generating pixel values or displayable video that is sent to a display interface 1710. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include Serial Advanced Technology Attachment (SATA), Peripheral Component Interconnect (PCI), Integrated Drive Electronics (IDE) interface, and the like. The techniques described in the present disclosure may be embodied in various electronic devices such as mobile phones, laptops, smartphones or other devices that are capable of performing digital data processing and/or video display.

It will be appreciated that the disclosed techniques may be embodied in video encoders or decoders to improve compression efficiency when the coding units being compressed have shaped that are significantly different than the traditional square shaped blocks or rectangular blocks that are half-square shaped. For example, new coding tools that use long or tall coding units such as 4×32 or 32×4 sized units may benefit from the disclosed techniques.

In some implementations, a method of video processing may be performed as follows:
using, during a conversion between a video block and a bitstream representation of the video block, a filtering method for calculating a spatial gradient and a temporal gradient, and
performing the conversion using the filtering.

Here, the conversion includes generating the bitstream representation from pixel values of the video

block or generating the pixels values from the bitstream representation.

In some embodiments, the spatial and temporal gradients are calculated using shifted sample differences.

In some embodiments, the spatial and temporal gradients are calculated using modified samples.

Additional details of this method are provided in item 1 discussed in Section 4.

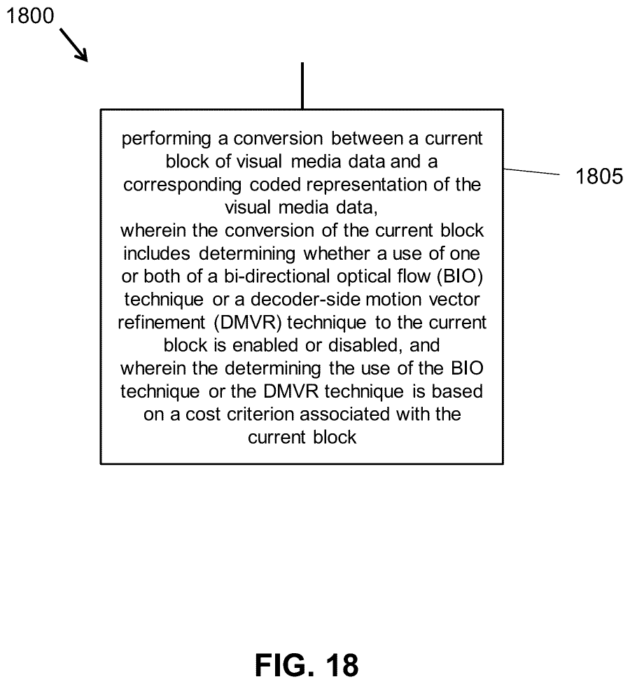

FIG. 18 is a flowchart for an example of a video processing method. Steps of this method are discussed in example 2 of Section 4 of this disclosure. The method includes (at step 1805) performing a conversion between a current block of visual media data and a corresponding coded representation of the visual media data, wherein the conversion of the current block includes determining whether a use of one or both of a bi-directional optical flow (BIO) technique or a decoder-side motion vector refinement (DMVR) technique to the current block is enabled or disabled, and wherein the determining the use of the BIO technique or the DMVR technique is based on a cost criterion associated with the current block.

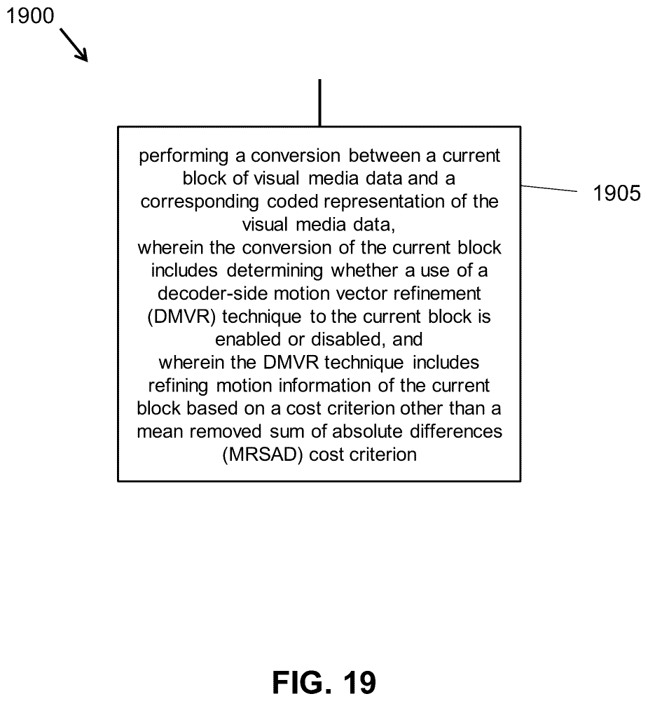

FIG. 19 is a flowchart for an example of a video processing method. Steps of this method are discussed in example 3 of Section 4 of this disclosure. The method includes (at step 1905) performing a conversion between a current block of visual media data and a corresponding coded representation of the visual media data, wherein the conversion of the current block includes determining whether a use of a decoder-side motion vector refinement (DMVR) technique to the current block is enabled or disabled, and wherein the DMVR technique includes refining motion information of the current block based on a cost criterion other than a mean removed sum of absolute differences (MRSAD) cost criterion.

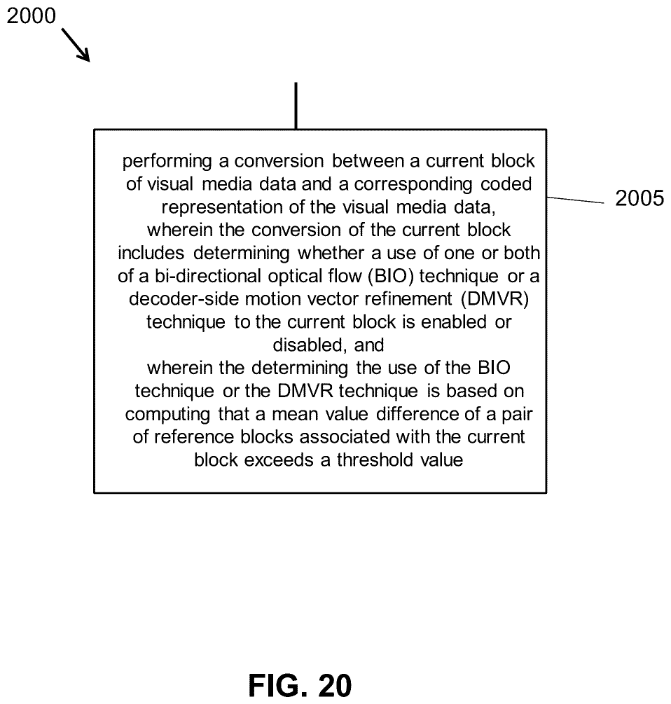

FIG. 20 is a flowchart for an example of a video processing method. Steps of this method are discussed in example 4 of Section 4 of this disclosure. The method includes (at step 2005) performing a conversion between a current block of visual media data and a corresponding coded representation of the visual media data, wherein the conversion of the current block includes determining whether a use of one or both of a bi-directional optical flow (BIO) technique or a decoder-side motion vector refinement (DMVR) technique to the current block is enabled or disabled, and wherein the determining the use of the BIO technique or the DMVR technique is based on computing that a mean value difference of a pair of reference blocks associated with the current block exceeds a threshold value.

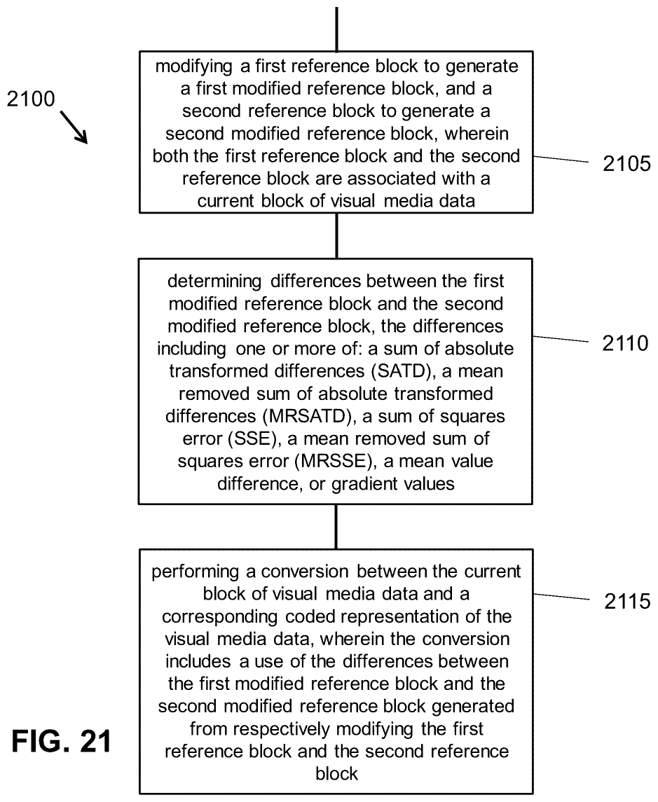

FIG. 21 is a flowchart for an example of a video processing method. Steps of this method are discussed in example 6 of Section 4 of this disclosure. The method includes (at step 2105) modifying a first reference block to generate a first modified reference block, and a second reference block to generate a second modified reference block, wherein both the first reference block and the second reference block are associated with a current block of visual media data. The method further includes (at step 2110) determining differences between the first modified reference block and the second modified reference block, the differences including one or more of: a sum of absolute transformed differences (SATD), a mean removed sum of absolute transformed differences (MRSATD), a sum of squares error (SSE), a mean removed sum of squares error (MRSSE), a mean value difference, or gradient values. The method includes (at step 2115) performing a conversion between the current block of visual media data and a corresponding coded representation of the visual media data, wherein the conversion includes a use of the differences between the first modified reference block and the second modified reference block generated from respectively modifying the first reference block and the second reference block.

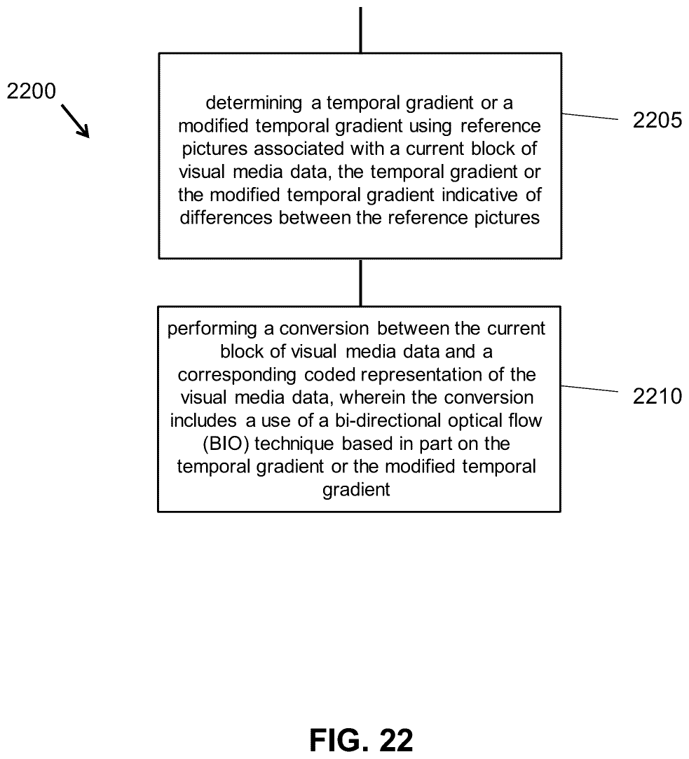

FIG. 22 is a flowchart for an example of a video processing method. Steps of this method are discussed in example 7 of Section 4 of this disclosure. The method includes (at step 2205) determining a temporal gradient or a modified temporal gradient using reference pictures associated with a current block of visual media data, the temporal gradient or the modified temporal gradient indicative of differences between the reference pictures. The method includes (at step 2210) performing a conversion between the current block of visual media data and a corresponding coded representation of the visual media data, wherein the conversion includes a use of a bi-directional optical flow (BIO) technique based in part on the temporal gradient or the modified temporal gradient.

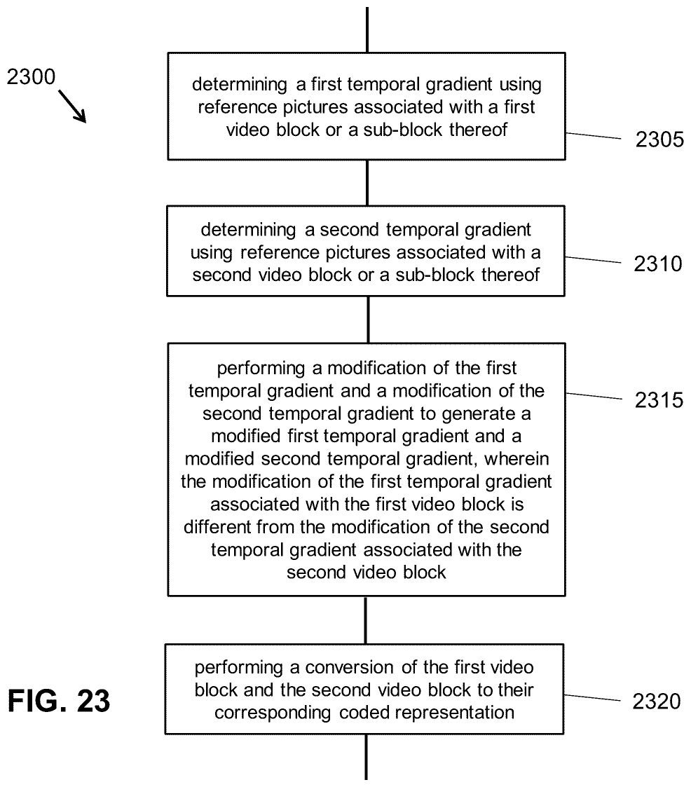

FIG. 23 is a flowchart for an example of a video processing method. Steps of this method are discussed in example 8 of Section 4 of this disclosure. The method includes (at step 2305) determining a first temporal gradient using reference pictures associated with a first video block or a sub-block thereof. The method includes (at step 2310) determining a second temporal gradient using reference pictures associated with a second video block or a sub-block thereof. The method includes (at step 2315) performing a modification of the first temporal gradient and a modification of the second temporal gradient to generate a modified first temporal gradient and a modified second temporal gradient, wherein the modification of the first temporal gradient associated with the first video block is different from the modification of the second temporal gradient associated with the second video block. The method includes (at step 2320) performing a conversion of the first video block and the second video block to their corresponding coded representation.

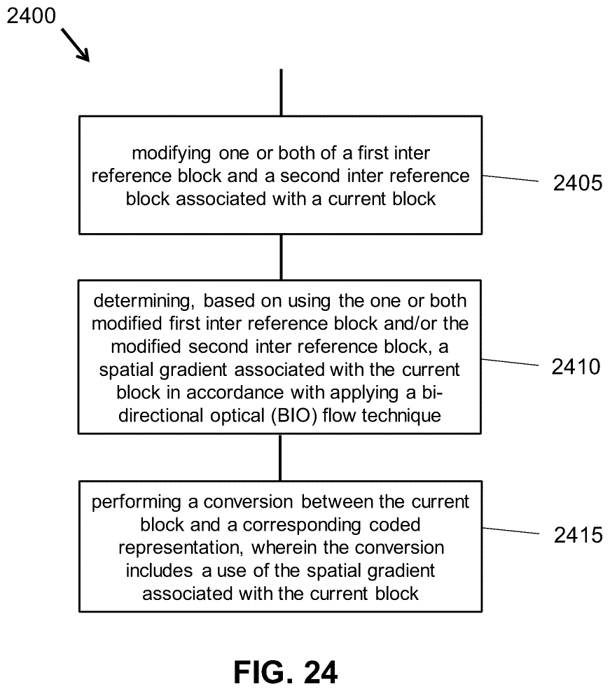

FIG. 24 is a flowchart for an example of a video processing method. Steps of this method are discussed in example 9 of Section 4 of this disclosure. The method includes (at step 2405) modifying one or both of a first inter reference block and a second inter reference block associated with a current block. The method includes (at step 2410) determining, based on using the one or both modified first inter reference block and/or the modified second inter reference block, a spatial gradient associated with the current block in accordance with applying a bi-directional optical (BIO) flow technique. The method includes (at step 2415) performing a conversion between the current block and a corresponding coded representation, wherein the conversion includes a use of the spatial gradient associated with the current block.

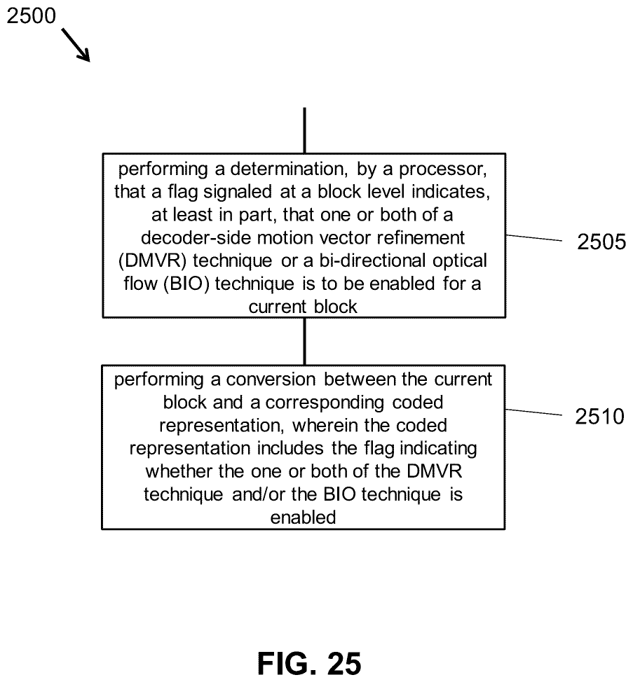

FIG. 25 is a flowchart for an example of a video processing method. Steps of this method are discussed in example 10 of Section 4 of this disclosure. The method includes (at step 2505) performing a determination, by a processor, that a flag which can be signaled at multiple levels indicates, at least in part, that one or both of a decoder-side motion vector refinement (DMVR) technique or a bi-directional optical flow (BIO) technique is to be enabled for a current block. The method includes (at step 2510) performing a conversion between the current block and a corresponding coded representation, wherein the coded representation includes the flag indicating whether the one or both of the DMVR technique and/or the BIO technique is enabled.

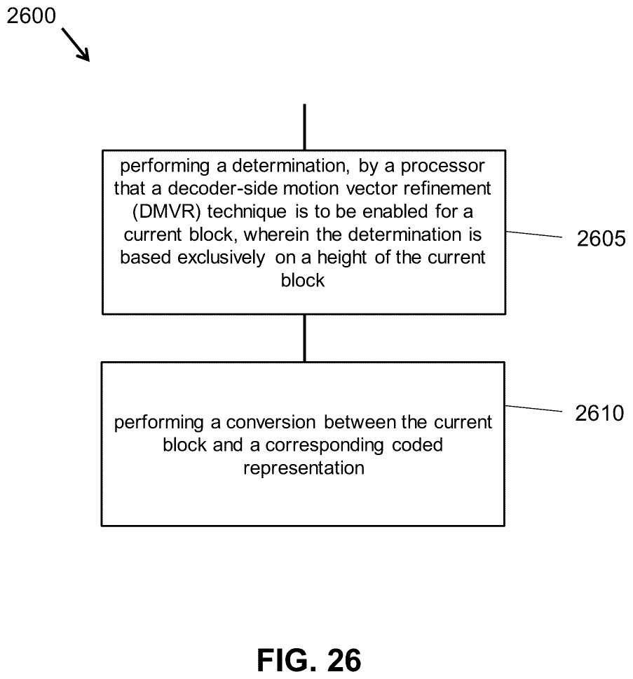

FIG. 26 is a flowchart for an example of a video processing method. Steps of this method are discussed in example 11 of Section 4 of this disclosure. The method includes (at step 2605) performing a determination, by a processor that a decoder-side motion vector refinement (DMVR) technique is to be enabled for a current block, wherein the determination is based exclusively on a height of the current block. The method includes (at step 2610) performing a conversion between the current block and a corresponding coded representation.

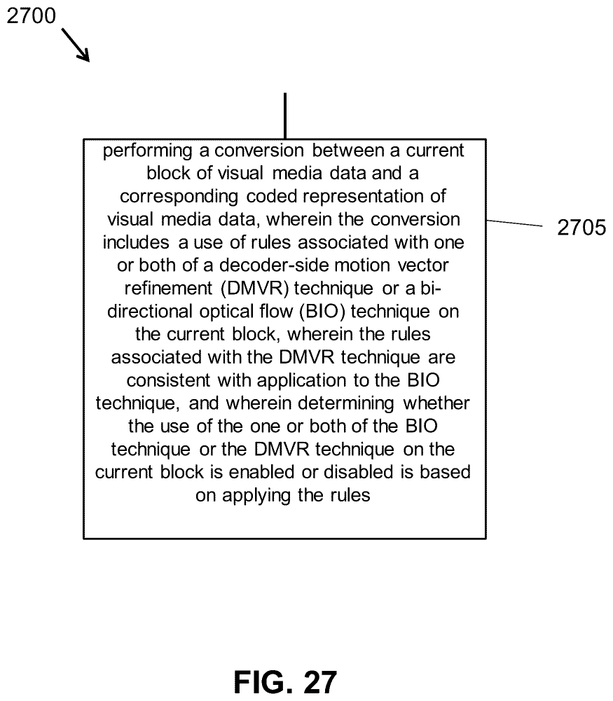

FIG. 27 is a flowchart for an example of a video processing method. Steps of this method are discussed in example 12 of Section 4 of this disclosure. The method includes (at step 2705) performing a conversion between a current block of visual media data and a corresponding coded representation of visual media data, wherein the conversion includes a use of rules associated with one or both of a decoder-side motion vector refinement (DMVR) technique or a bi-directional optical flow (BIO) technique on the current block, wherein the rules associated with the DMVR technique are consistent with application to the BIO technique, and wherein determining whether the use of the one or both of the BIO technique or the DMVR technique on the current block is enabled or disabled is based on applying the rules.

Some embodiments of the present technology are discussed in clause-based format.
1. A method of visual media processing, comprising:
   performing a conversion between a current block of visual media data and a corresponding coded representation of the visual media data,
   wherein the conversion of the current block includes determining whether a use of one or both of a bi-directional optical flow (BIO) technique or a decoder-side motion vector refinement (DMVR) technique to the current block is enabled or disabled, and
   wherein the determining the use of the BIO technique or the DMVR technique is based on a cost criterion associated with the current block.
2. The method of clause 1, wherein the cost criterion is based on one or more of: a sum of absolute transformed differences (SATD), a mean removed sum of absolute transformed differences (MRSATD), a sum of squares error (SSE), a mean removed sum of squares error (MRSSE), a mean value difference, or gradient values.
3. The method of any one or more of clauses 1-2, wherein the cost criterion is associated with a sub-block of the current block.
4. The method of clause 3, wherein a sub-block-level cost criterion is different from a block-level cost criterion.
5. The method of any one or more of clauses 1-4, further comprising:
   upon determining that one or more of the gradient values, an average of the gradient values, or a range of the gradient values is outside a threshold range, disabling application of the BIO technique and/or the DMVR technique.
6. The method of clause 1, wherein the cost criterion associated with the current block is signaled in the coded representation.
7. The method of clause 6, wherein the cost criterion is signaled in a video parameter set (VPS), a sequence parameter set (SPS), a picture parameter set (PPS), a tile group header, a picture header, or a slice header.
8. A method of visual media processing, comprising:
   performing a conversion between a current block of visual media data and a corresponding coded representation of the visual media data,
   wherein the conversion of the current block includes determining whether a use of a decoder-side motion vector refinement (DMVR) technique to the current block is enabled or disabled, and
   wherein the DMVR technique includes refining motion information of the current block based on a cost criterion other than a mean removed sum of absolute differences (MRSAD) cost criterion.
9. The method of clause 8, wherein the cost criterion associated with the current block is based on one or more of: a sum of absolute transformed differences (SATD), a mean removed sum of absolute transformed differences (MRSATD), a sum of squares error (SSE), or a mean removed sum of squares error (MRSSE).
10. The method of any one or more of clauses 8-9, wherein the cost criterion is associated with a sub-block of the current block.
11. The method of clause 10, further comprising:
   splitting the current block into multiple sub-blocks of size M×N, wherein the cost criterion is based on the motion information associated with each of the multiple sub-blocks; and
   generating costs corresponding to each of the multiple sub-blocks.
12. The method of clause 11, further comprising:
summing at least a subset of the costs corresponding to each of the multiple sub-blocks to generate a resulting cost associated with the current block.
13. A method of visual media processing, comprising:
   performing a conversion between a current block of visual media data and a corresponding coded representation of the visual media data,
   wherein the conversion of the current block includes determining whether a use of one or both of a bi-directional optical flow (BIO) technique or a decoder-side motion vector refinement (DMVR) technique to the current block is enabled or disabled, and
   wherein the determining the use of the BIO technique or the DMVR technique is based on computing that a mean value difference of a pair of reference blocks associated with the current block exceeds a threshold value.
14. The method of clause 13, wherein the threshold value is a first threshold value, further comprising:
   upon determining that a mean value difference of a pair of reference sub-blocks associated with a sub-block of the current block exceeds a second threshold value, disabling application of the BIO technique and/or the DMVR technique.
15. The method of clause 14, wherein the first threshold value and/or the second threshold value are predefined numbers.
16. The method of clause 14, wherein the first threshold value and/or the second threshold value are based on dimensions of the current block.
17. A method of visual media processing, comprising:
   modifying a first reference block to generate a first modified reference block, and a second reference block to generate a second modified reference block, wherein both the first reference block and the second reference block are associated with a current block of visual media data;
   determining differences between the first modified reference block and the second modified reference block, the differences including one or more of: a sum of absolute transformed differences (SATD), a mean removed sum of absolute transformed differences (MRSATD), a sum of squares error (SSE), a mean removed sum of squares error (MRSSE), a mean value difference, or gradient values; and
   performing a conversion between the current block of visual media data and a corresponding coded representation of the visual media data, wherein the conversion includes a use of the differences between the first modified reference block and the second modified reference block generated from respectively modifying the first reference block and the second reference block.
18. The method of clause 17, wherein the modifying the first reference block and the second reference block includes:
   computing a first arithmetic mean based on sample values included in the first reference block and a second arithmetic mean based on sample values included in the second reference block;
   subtracting the first arithmetic mean from samples included in the first reference block and the second arithmetic mean from samples included in the second reference block.
19. The method of clause 18, wherein the first arithmetic mean and the second arithmetic mean are based on a subset of samples respectively included in the first reference block and the second reference block.
20. The method of any one or more of clauses 17-19, wherein the first reference block and/or the second reference block are sub-blocks associated with the current block.
21. A method of visual media processing, comprising:
   determining a temporal gradient or a modified temporal gradient using reference pictures associated with a current block of visual media data, the temporal gradient or the modified temporal gradient indicative of differences between the reference pictures; and
   performing a conversion between the current block of visual media data and a corresponding coded representation of the visual media data, wherein the conversion includes a use of a bi-directional optical flow (BIO) technique based in part on the temporal gradient or the modified temporal gradient.
22. The method of clause 21, further comprising:
   prematurely terminating the BIO technique, in response to determining that the temporal gradient or the modified temporal gradient is less than or equal to a threshold.
23. The method of clause 22, further comprising:
   adjusting the threshold based on the number of samples used for calculating an absolute sum of the temporal gradient or the modified gradient.
24. The method of any one or more of clauses 21-23, wherein the differences are related to an absolute sum of the temporal gradient.'
25. The method of any one or more of clauses 21-24, wherein the differences between the reference pictures correspond to differences between a first portion of a first reference picture and a second portion of a second reference picture.
26. The method of any one or more of clauses 21-25, wherein the reference pictures are associated with a sub-block of the current block.
27. A method of visual media processing, comprising:
   determining a first temporal gradient using reference pictures associated with a first video block or a sub-block thereof;
   determining a second temporal gradient using reference pictures associated with a second video block or a sub-block thereof;
   performing a modification of the first temporal gradient and a modification of the second temporal gradient to generate a modified first temporal gradient and a modified second temporal gradient, wherein the modification of the first temporal gradient associated with the first video block is different from the modification of the second temporal gradient associated with the second video block; and
   performing a conversion of the first video block and the second video block to their corresponding coded representation.
28. The method of clause 27, wherein the modification of the first temporal gradient and/or the modification of the second temporal gradient is conditionally based on an absolute mean difference between the reference pictures associated with the first video block and/or the second video block being greater than a threshold value.
29. The method of clause 28, wherein the threshold value is 4.
30. The method of clause 27, wherein the modification of the first temporal gradient and/or the modification of the second temporal gradient is conditionally based on an absolute mean difference between the reference pictures associated with the first video block and/or the second video block being less than a threshold value.
31. The method of clause 30, wherein the threshold value is 20.
32. The method of clause 27, wherein the modification of the first temporal gradient and/or the modification of the second temporal gradient is conditionally based on an absolute mean difference between the reference pictures associated with the first video block and/or the second video block being within a threshold range.
33. The method of any of clauses 27-32, further comprising:
   disabling a use of a bi-directional optical flow (BIO) technique on the first video block and/or the second block based on an absolute mean difference between the reference pictures associated with the first video block and/or the second video block being greater than a threshold value.
34. The method of any one or more of clauses 27-33, wherein the threshold value or the threshold range is indicated in VPS, SPS, PPS, a picture, a slice, or a tile level associated with the first video block and/or the second video block.
35. The method of any one or more of clauses 27-33, wherein the threshold value or the threshold range are implicitly predefined parameters.
36. The method of any one or more of clauses 27-33, wherein the threshold value or the threshold range is different for different coding units (CUs), largest coding units (LCUs), slices, tiles, or pictures associated with the first video block and/or the second video block.
37. The method of any one or more of clauses 27-33, wherein the threshold value or the threshold range is based on a decoded or an encoded pixel value associated with the first video block and/or the second video block.
38. The method of any one or more of clauses 27-33, wherein the threshold value or the threshold range for a first set of reference pictures is different from the threshold value or the threshold range for a second set of reference pictures.
39. The method of clause 27, wherein the modification of the first temporal gradient and/or the modification of the second temporal gradient is conditionally based on an absolute mean of the reference pictures associated with the first video block and/or the second video block being greater than a threshold value.
40. The method of clause 39, wherein the threshold value is 40.
41. The method of clause 27, wherein the modification of the first temporal gradient and/or the modification of the second temporal gradient is conditionally based on an absolute mean of the reference pictures associated with the first video block and/or the second video block being smaller than a threshold value.
42. The method of clause 41, wherein the threshold value is 100.
43. The method of clause 27, wherein the modification of the first temporal gradient and/or the modification of the second temporal gradient is conditionally based on an absolute mean of the reference pictures associated with the first video block and/or the second video block being within a threshold range.
44. The method of clause 27, wherein the modification of the first temporal gradient and/or the modification of the second temporal gradient is conditionally based on an absolute mean of the reference pictures associated with the first video block and/or the second video block being greater than an absolute mean difference of the reference pictures associated with the first video block and/or the second video block times a multiplication factor.
45. The method of clause 27, wherein the modification of the first temporal gradient and/or the modification of the second temporal gradient is conditionally based on an absolute mean of the reference pictures associated with the first video block and/or the second video block being less than an absolute mean difference of the reference pictures associated with the first video block and/or the second video block times a multiplication factor.
46. The method of any one or more of clauses 44-45, wherein the multiplication factor is 4.5.
47. A method of visual media processing, comprising:
   modifying one or both of a first inter reference block and a second inter reference block associated with a current block;
   determining, based on using the one or both modified first inter reference block and/or the modified second inter reference block, a spatial gradient associated with the current block in accordance with applying a bi-directional optical (BIO) flow technique; and
performing a conversion between the current block and a corresponding coded representation, wherein the conversion includes a use of the spatial gradient associated with the current block.
48. The method of clause 47, wherein determining the spatial gradient includes:
   generating two prediction blocks based on a weighted averaging of an intra prediction block and an inter prediction block associated with the current block; and
   using the two prediction blocks for determining the spatial gradient associated with the current block.
49. The method of clause 48, further comprising:
   generating, using the BIO technique, a refined prediction block from the two prediction blocks; and
   using the refined prediction block for predicting sub-blocks and/or samples of the current block.
50. A method of visual media processing, comprising:
   performing a determination, by a processor, that a flag which can be signaled at multiple levels indicates, at least in part, that one or both of a decoder-side motion vector refinement (DMVR) technique or a bi-directional optical flow (BIO) technique is to be enabled for a current block; and
   performing a conversion between the current block and a corresponding coded representation, wherein the coded representation includes the flag indicating whether the one or both of the DMVR technique and/or the BIO technique is enabled.
51. The method of clause 50, wherein the flag is signaled in the coded representation in response to detecting that an advanced motion vector prediction (AMVP) technique is enabled for the current block.
52. The method of clause 50, wherein the flag is derived from one or both of spatial neighboring blocks or temporal neighboring blocks associated with the current block in response to detecting that a merge mode is enabled for the current block.
53. The method of clause 52, wherein, the flag is inherited from a selected merging candidate if the selected merging candidate is a spatial merging candidate.
54. The method of clause 52, wherein, the flag is inherited from a selected merging candidate if the selected merging candidate is a temporal merging candidate.
55. The method of clause 50, wherein, a cost criterion associated with the current block is used to determine whether the one or both of the DMVR technique and/or the BIO technique is enabled, and the flag signaled in the coded representation is used to indicate whether such determination is correct or not.
56. The method of clause 55, wherein the cost criterion associated with the current block is a sum of absolute difference (SAD) between two reference blocks of the current block, and wherein the determination that the one or both of the DMVR technique and/or the BIO technique is enabled applies when the cost criterion is greater than a threshold.
57. The method of clause 50, further comprising:
   upon determining that the current block is a uni-predicted block, skipping signaling of the flag in the coded representation.
58. The method of clause 50, further comprising:
   upon determining that the current block is a bi-predicted block associated with a pair of reference pictures both of which are either preceding or succeeding in a display order, skipping signaling of the flag in the coded representation.
59. The method of clause 50, further comprising:
   upon determining that the current block is a bi-predicted block associated with a pair of reference pictures with different picture order count (POC) distances from a current picture associated with the current block, skipping signaling of the flag in the coded representation.
60. The method of clause 50, further comprising:
   upon determining that the current block is an intra coded block, skipping signaling of the flag in the coded representation.
61. The method of clause 50, further comprising:
   upon determining that the current block is a hybrid intra and inter predicted block, skipping signaling of the flag in the coded representation.
62. The method of clause 50, further comprising:
   upon determining that the current block is associated with at least one block of a picture same as a reference block, skipping signaling of the flag in the coded representation.
63. The method of clause 50, further comprising:
   upon determining that a dimension of the current block is smaller than a threshold value, skipping signaling of the flag in the coded representation.
64. The method of clause 50, further comprising:
   upon determining that a dimension of the current block is greater than or equal to a threshold value, skipping signaling of the flag in the coded representation.
65. The method of clause 50, further comprising:
   upon determining that a precision of motion information associated with the current block is an integer precision, skipping signaling of the flag in the coded representation.
66. The method of clause 50, further comprising:
   upon determining that a temporal layer associated with the picture containing the current block is beyond a threshold value, skipping signaling of the flag in the coded representation.
67. The method of clause 50, further comprising:
   upon determining that a quantization parameter associated with the current block is beyond a threshold value, skipping signaling of the flag in the coded representation.
68. The method of any one or more of clauses 50-67, further comprising:
   in response to determining that signaling of the flag in the coded representation is skipped, deriving a value of the flag as a Boolean true or false.
69. The method of any one or more of clauses 50-67, further comprising:
   upon determining that the flag is a Boolean true, enabling the one or both of the DMVR technique or the BIO technique.
70. The method of any one or more of clauses 50-67, further comprising:
   upon determining that the flag is a Boolean false, disabling the one or both of the DMVR technique or the BIO technique.
71. The method of any one or more of clauses 50-67, further comprising:
   upon determining that the flag is a Boolean true, the determination of the enabling or disabling one or both of the DMVR technique or the BIO technique based on at least one cost criterion is determined as correct.
72. The method of any one or more of clauses 50-67, further comprising:
   upon determining that the flag is a Boolean false, the determination of the enabling or disabling one or both of the DMVR technique or the BIO technique based on at least one cost criterion is determined as incorrect.
73. The method of any one or more of clause 50-67, wherein the flag is signaled in a slice header, a picture header, a tile header, a Video Parameter Set (VPS), a Sequence Parameter Set (SPS), or a Picture Parameter Set (PPS).
74. The method of clause 50, wherein a first flag is signaled to indicate whether the DMVR technique is enabled or not, and a second flag is signaled to indicate whether the BIO technique is enabled or not.
75. The method of any one or more of clauses 64-74, further comprising:
   upon determining that the flag for the DMVR technique is a Boolean true, disabling the DMVR technique for a slice, a tile, a video, a sequence or a picture. p1 76. The method of any one or more of clauses 64-74, further comprising:
   upon determining that the flag for the DMVR technique is a Boolean false, enabling the DMVR technique for a slice, a tile, a video, a sequence or a picture.
77. The method of any one or more of clauses 64-74, further comprising:
   upon determining that the flag for the BIO technique is a Boolean true, disabling the BIO technique for a slice, a tile, a video, a sequence or a picture.
78. The method of any one or more of clauses 64-74, further comprising:
   upon determining that the flag for the BIO technique is a Boolean false, enabling the BIO technique for a slice, a tile, a video, a sequence or a picture.
79. A method of visual media processing, comprising:
   performing a determination, by a processor that a decoder-side motion vector refinement (DMVR) technique is to be enabled for a current block, wherein the determination is based exclusively on a height of the
   performing a conversion between the current block and a corresponding coded representation.
80. The method of clause 79, further comprising:
   in response to determining that the DMVR technique is enabled, verifying that the height of the current block is greater than or exceeds a threshold parameter.
81. The method of clause 80, wherein the threshold parameter equals 4.
82. The method of clause 80, wherein the threshold parameter equals 8.
83. A method of visual media processing, comprising:
   performing a conversion between a current block of visual media data and a corresponding coded representation of visual media data, wherein the conversion includes a use of rules associated with one or both of a decoder-side motion vector refinement (DMVR) technique or a bi-directional optical flow (BIO) technique on the current block, wherein the rules associated with the DMVR technique are consistent with application to the BIO technique; and
   wherein determining whether the use of the one or both of the BIO technique or the DMVR technique on the current block is enabled or disabled is based on applying the rules.
84. The method of clause 83, wherein a rule to determine whether the DMVR technique is enabled is same as a rule to determine whether the BIO technique is enabled.
85. The method of clause 84, wherein the rule to determine whether the BIO technique and/or the DMVR technique is enabled specifies verifying that a height of the current block is greater than or equal to a threshold value.
86. The method of clause 84, wherein the rule to determine whether the BIO technique and/or the DMVR technique is enabled specifies verifying that both of a width and a height of the current block are greater than or equal to a threshold value.
87. The method of any one or more of clauses 85 or 86, wherein the threshold value is 4 or 8.
88. The method of clause 84, wherein the rule to determine whether the BIO technique and/or the DMVR technique is enabled specifies verifying that a size of the current block is greater than or equal to a threshold value.
89. The method of clause 86, wherein the threshold value is 64 or 128.
90. The method of clause 84, wherein the rule to determine whether the BIO technique and/or the DMVR technique is enabled specifies verifying that the current block is not coded in a Bi-prediction with CU-level Weight (BCW) mode, wherein unequal weights are used for two reference blocks from two reference lists.
91. The method of clause 84, wherein the rule to determine whether the BIO technique and/or the DMVR technique is enabled specifies verifying that the current block is a bi-predicted block associated with a pair of reference pictures with a same picture order count (POC) distance from a current picture associated with the current block.
92. The method of clause 91, wherein the pair of reference pictures include a preceding picture and a succeeding picture of the current picture associated with the current block, in display order.
93. A video decoding apparatus comprising a processor configured to implement a method recited in one or more of clauses 1 to 92.
94. A video encoding apparatus comprising a processor configured to implement a method recited in one or more of clauses 1 to 92.
95. A computer program product having computer code stored thereon, the code, when executed by a processor, causes the processor to implement a method recited in any of clauses 1 to 92.
96. A method, apparatus or system described in the present disclosure.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of particular techniques. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

What is claimed is:

1. A method of processing video data, comprising:
performing a determination, by a processor, that a flag which can be signaled at multiple levels indicates, at least in part, that one or both of a decoder-side motion vector refinement (DMVR) technique and a bi-directional optical flow (BIO) technique is to be enabled for a current block; and
performing a conversion between the current block and a bitstream, wherein the bitstream includes the flag indicating whether the one or both of the DMVR technique and the BIO technique is enabled.

2. The method of claim 1, wherein the flag is signaled in the bitstream in response to detecting that an advanced motion vector prediction (AMVP) technique is enabled for the current block.

3. The method of claim 1, wherein the flag is derived from one or both of spatial neighboring blocks or temporal neighboring blocks associated with the current block in response to detecting that a merge mode is enabled for the current block.

4. The method of claim 3, wherein the flag is inherited from a selected merging candidate when the selected merging candidate is a spatial merging candidate or a temporal merging candidate.

5. The method of claim 1, wherein, a cost criterion associated with the current block is used to determine whether the one or both of the DMVR technique and/or the BIO technique is enabled, and the flag signaled in the bitstream is used to indicate whether such determination is correct or not.

6. The method of claim 5, wherein the cost criterion associated with the current block is a sum of absolute difference (SAD) between two reference blocks of the current block, and wherein the determination that the one or both of the DMVR technique and/or the BIO technique is enabled applies when the cost criterion is greater than a threshold.

7. The method of claim 1, further comprising skipping signaling of the flag in the bitstream upon determining at least one of:
that the current block is one of a uni-predicted block, a bi-predicted block associated with a pair of reference pictures both of which are either preceding or succeeding in a display order, a bi-predicted block associated with a pair of reference pictures with different picture order count (POC) distances from a current picture associated with the current block, an intra coded block, and a hybrid intra and inter predicted block,
that the current block is associated with at least one block of a picture same as a reference block,
that a dimension of the current block is smaller than a first threshold value,
that the dimension of the current block is greater than or equal to a second threshold value,
that a precision of motion information associated with the current block is an integer precision,
that a temporal layer associated with the picture containing the current block is beyond a third threshold value, and
that a quantization parameter associated with the current block is beyond a fourth threshold value.

8. The method of claim 1, further comprising deriving, in response to determining that signaling of the flag in the bitstream is skipped, a value of the flag as a Boolean true or false.

9. The method of claim 1, further comprising enabling, upon determining that the flag is a Boolean true the one or both of the DMVR technique or the BIO technique.

10. The method of claim 1, further comprising disabling, upon determining that the flag is a Boolean false, the one or both of the DMVR technique or the BIO technique.

11. The method of claim 1, further comprising determining, when the flag is a Boolean true, that the enabling or disabling one or both of the DMVR technique and the BIO technique determined based on at least one cost criterion is correct.

12. The method of claim 1, further comprising determining, when the flag is a Boolean false, that the enabling or disabling one or both of the DMVR technique and the BIO technique determined based on at least one cost criterion is incorrect.

13. The method of claim 1, wherein the flag is included in a slice header, a picture header, a tile header, a Video Parameter Set (VPS), a Sequence Parameter Set (SPS), or a Picture Parameter Set (PPS).

14. The method of claim 1, wherein a first flag is included in the bitstream to indicate whether the DMVR technique is enabled or not, and a second flag is included in the bitstream to indicate whether the BIO technique is enabled or not.

15. The method of claim 7, further comprising at least one of:
upon determining that the flag for the DMVR technique is a Boolean true, disabling the DMVR technique for a slice, a tile, a video, a sequence, or a picture; and
upon determining that the flag for the BIO technique is a Boolean true, disabling the BIO technique for a slice, a tile, a video, a sequence, or a picture.

16. The method of claim 7, further comprising at least one of:
upon determining that the flag for the DMVR technique is a Boolean false, enabling the DMVR technique for a slice, a tile, a video, a sequence, or a picture; and
upon determining that the flag for the BIO technique is a Boolean false, enabling the BIO technique for a slice, a tile, a video, a sequence, or a picture.

17. The method of claim 1, wherein the conversion includes encoding the current block into the bitstream.

18. The method of claim 1, wherein the conversion includes decoding the current block from the bitstream.

19. An apparatus for processing video data comprising a processor and a non-transitory memory with instructions thereon, wherein the instructions upon execution by the processor, cause the processor to:
perform a determination, that a flag which can be signaled at multiple levels indicates, at least in part, that one or both of a decoder-side motion vector refinement (DMVR) technique and a bi-directional optical flow (BIO) technique is to be enabled for a current block; and
perform a conversion between the current block and a bitstream, wherein the bitstream includes the flag indicating whether the one or both of the DMVR technique and the BIO technique is enabled.

20. A non-transitory computer-readable recording medium storing a bitstream of a video which is generated by a method performed by a video processing apparatus, wherein the method comprises:
performing a determination, that a flag which can be signaled at multiple levels indicates, at least in part, that one or both of a decoder-side motion vector refinement (DMVR) technique and a bi-directional optical flow (BIO) technique is to be enabled for a current block; and
generating the bitstream from the current block based on the determination, wherein the bitstream includes the flag indicating whether the one or both of the DMVR technique and the BIO technique is enabled.
